(19) United States
(12) Patent Application Publication
(10) Pub. No.: US 2026/0225269 A1
(43) Pub. Date: Aug. 6, 2026

(54) DUAL-MODE SINGLE-ACTION CONVERTIBLE UTILITY KNIFE AND SCRAPER

(71) Applicants: Michael H Panosian, Irvine, CA (US); Joshua M Keeler, Irvine, CA (US)

(72) Inventors: Michael H Panosian, Irvine, CA (US); Joshua M Keeler, Irvine, CA (US)

(21) Appl. No.: 19/043,472

(22) Filed: Feb. 2, 2025

(51) Int. Cl. B26B 5/00; B25F 1/04; B26B 11/00; B67B 7/14

(52) U.S. Cl. CPC B26B 5/003; B25F 1/04; B26B 11/006; B67B 7/14

(57) ABSTRACT

A system and a method are disclosed including a dual-mode, single-action convertible knife external housing that provides structural support for maintaining the blade orientation and integrity in various states of the knife and its operational modes. The convertible knife may have two modes of operation, cutting and scraping, which may transition from one mode to the other by a single uniform action of a user. The blades usable with the convertible knife include a trapezoidal cut-out held firmly in place by a trapezoidal protrusion of a blade clamp assembly and other structural elements. The convertible knife scraping mode provides an asymmetrical front-end configuration that allows the blade to get closer to the scraped surface compared with a symmetrical configuration to allow a shallower and more effective scraping angle.

### CROSS-REFERENCES TO RELATED APPLICATIONS

None.

### TECHNICAL FIELD

This application relates generally to cutting tools, utility knives and scrapers. More specifically, this application relates to a single-action dual-mode utility knife that converts between a cutting configuration and a scraping configuration.

### BRIEF DESCRIPTION OF THE DRAWINGS

The drawings, when considered in connection with the following description, are presented for the purpose of facilitating an understanding of the subject matter sought to be protected.

FIG. 1A shows an example view of a convertible knife in a scraping configuration;

FIG. 1B shows an example view of the convertible knife of FIG. 1A in a cutting configuration;

FIG. 1C shows an example view of a rear end of the convertible knife of FIG. 1A having a paint can opener;

FIG. 2A shows an example cut-away view of a blade carriage assembly deployed within the convertible knife of FIG. 1A;

FIG. 2B shows an example view of the blade carriage assembly in a cutting mode;

FIG. 2C shows an example exploded view of the blade carriage assembly and a blade in scraper mode;

FIG. 3A shows an example cut-away view of the convertible knife of FIG. 1A in the scraping configuration;

FIG. 3B shows an example side view of the convertible knife of FIG. 1A;

FIG. 4A shows an example view of the convertible knife of FIG. 1B with blade rotation slot in a housing of the convertible knife;

FIG. 4B shows an example cut-away view of the convertible knife of FIG. 1B in the cutting configuration;

FIG. 4C shows an example cut-away view of the convertible knife of FIG. 1A, with a blade clamp assembly;

FIG. 4D shows an example cut-away view of the convertible knife of FIUGRE 1B, with the blade in a retracted state;

FIG. 4E shows an example cut-away view of the convertible knife of FIGURE lA, with top and bottom structural support for the blade;

FIG. 4F shows an example cut-away view of the convertible knife of FIGURE lA, with side structural support for the blade;

FIG. 5A shows an example exploded view of the blade clamp assembly; FIG. 5B shows another example top view of the blade clamp assembly; FIG. 5C shows an example exploded view of the blade clamp assembly;

FIG. 6A shows an example view of the convertible knife of FIG. 1A identifying a cross-section A-A;

FIG. 6B shows the example cross-section A-A of FIG. 6A;

FIG. 6C shows an example view of the blade carriage assembly with blade carriage stop;

FIG. 6D shows an example view of the blade carriage assembly of FIG. 6C with a blade pull stop tab;

FIG. 6E shows an example cut-away exploded view of the blade carriage assembly of FIG. 6C with slider button stops;

FIG. 6F shows an example cut-away view of a slider assembly coupled with the blade carriage assembly;

FIG. 7A shows an example cut-away of the blade carriage assembly with a cross- section A-A and internal tracks that guide knife configuration conversion;

FIG. 7B shows an example view of the cross-section A-A of FIG. 7A of the internal guide grooves of the blade carriage assembly;

FIG. 7C shows an example operational diagram of conversion of knife configurations;

FIG. 7D shows an example view of the blade clamp assembly with clamp pivot and blade rotation bar;

FIG. 7E shows an example view of a knife mode conversion mechanism in the cutting mode;

FIG. 7F shows an example view of the knife mode conversion mechanism in transition between the cutting mode and the scraping mode;

FIG. 7G shows an example view of a knife mode conversion mechanism in scraping mode;

FIG. 7H shows an example view of a knife mode conversion mechanism in transition between the scraping mode and the cutting mode; and

FIG. 71 shows an example view of a knife mode conversion mechanism in cutting mode while the mechanism is still in transition.

### DETAILED DESCRIPTION

While the present disclosure is described with reference to several illustrative embodiments and example devices described herein, it should be clear that the present disclosure should not be limited to such embodiments. Therefore, the description of the embodiments provided herein is illustrative of the present disclosure and should not limit the scope of the disclosure as claimed. In addition, while following description references particular configurations of blade clamp and slider assembly, it will be appreciated that the disclosure may be applicable with other types of blade clamp and slider assembly.

Briefly described, a system and a method are disclosed including a dual-mode, single- action convertible knife external housing that provides structural support for maintaining the blade orientation and integrity in various states of the knife and its operational modes. The convertible knife may have two modes of operation, cutting and scraping, which may transition from one mode to the other by a single uniform action of a user. The blades usable with the convertible knife include a trapezoidal cut-out held firmly in place by a trapezoidal protrusion of a blade clamp assembly and other structural elements. This arrangement allows more exposure of blade edge for enhanced functionality. The blade clamp assembly includes a blade release button that is hidden in scraper mode. The structural support provided by the housing resist blade and/or blade clamp assembly and the blade carriage assembly from unintentional rotation or other movements. The convertible knife scraping mode provides an asymmetrical front-end configuration that allows the blade to get closer to the scraped surface compared with a symmetrical configuration to allow a shallower and more effective scraping angle. The convertible knife further includes a blade carriage assembly that includes a blade clamp assembly for holding the blade securely in place.

The blade carriage assembly includes multiple guide tracks (grooves embedded in the blade carriage assembly wall surface) that guide an arm pin to convert the operational mode (knife or scraper) of the convertible knife. Each guide track may include a landing recess that ensures smooth transition of the arm pin from one guide track to the next one when activated by the user. The arm may be used to push a blade rotation bar coupled with the blade clamp assembly. The convertible knife further includes a slider assembly that couples a slider button to the blade carriage assembly, the slider button being surrounded by a safety frame to prevent unintentional movement of the slider assembly. The blade carriage assembly includes internal rails that aid in smooth siding of the blade carriage assembly when activated by the slider assembly. The slider assembly includes a blade pull stop tab to prevent blade carriage assembly movement in knife mode. The convertible knife assembly further includes a paint can opener on its rear end.

In various embodiments, a convertible knife is disclosed including a knife housing with hollow interior, a blade carriage assembly slidably deployed within the knife housing, a blade clamp assembly rotatably coupled with the blade carriage assembly, and a blade release assembly coupled with the blade clamp assembly and including three blade pins to securely hold a blade in the blade clamp assembly.

In various embodiments, a dual-mode knife is disclosed including a hollow knife housing, a blade carriage assembly deployed within the hollow knife housing, and a slider button coupled with the blade carriage assembly and the hollow knife housing. The slider button may include two detents to engage stops incorporated in the hollow knife housing and hold the blade carriage assembly in one of several predetermined positions within the hollow knife housing.

In various embodiments, A method of converting a first mode of operation to a second mode of operation in a dual-mode knife is disclosed, including pressing a slider button, having an integrated detent, to slide a blade carriage assembly forward in a hollow knife housing, and rotating a blade clamp assembly, coupled with the blade carriage assembly, from a first position to a second position to convert from the first mode of operation to the second mode of operation. The blade carriage assembly includes a guide grooves network having a plurality guide grooves, each guide groove having a groove pin landing.

Building contractors, construction crews, carpet layers, private do-it-yourself (DIY) people, shipping operations and warehouses that use cutting instruments, often use utility knives, sometimes referred to as box cutters, to cut cardboard boxes, sheets, ropes, materials, and use it for other similar cutting applications. In addition to cutting applications, painters, construction workers, and other repair, cleaning, or manufacturing personnel often need to clean spots, glue, paint, and other surface contaminants from various surfaces such as glasses, countertops, floors, doors, and other hard surfaces using a flat hard tool such as a razor blade to scrape off the contaminant. or Most utility knives on the market have a single operating blade. Some have a storage compartment inside the knife's body for quicker and ready access to new and sharp blades. The need for cutting and scrapping often occur in the same project or activity. As such, the user often needs to carry two different tools, one for cutting and one for scrapping.

Therefore, there is a need for a single tool that may be used both as a cutter and as a scrapper that may be quickly and easily adapted to either function without the use of tools or having to disassemble the tools and reassemble it into a different configuration.

It is to be noted that directions, orientations, and other relative terms such as "front", "back", "top", "bottom", "left", "right", "inside", "outside", "interior", "exterior", "downward", "upward", "front-facing", "down-facing", "vertical", "horizontal", "diagonal", and the like are described with respect or relative to a distinguishing feature of the system or device body itself. For example, if the front part or surface of a system body or an object is identified in the description, then rear or back is defined as the part or surface opposite the front surface, left is defined as the left side when looking into the front surface, and so on. As long as directions are unambiguously identifiable based on the descriptions and figures, how the orientations are defined is immaterial.

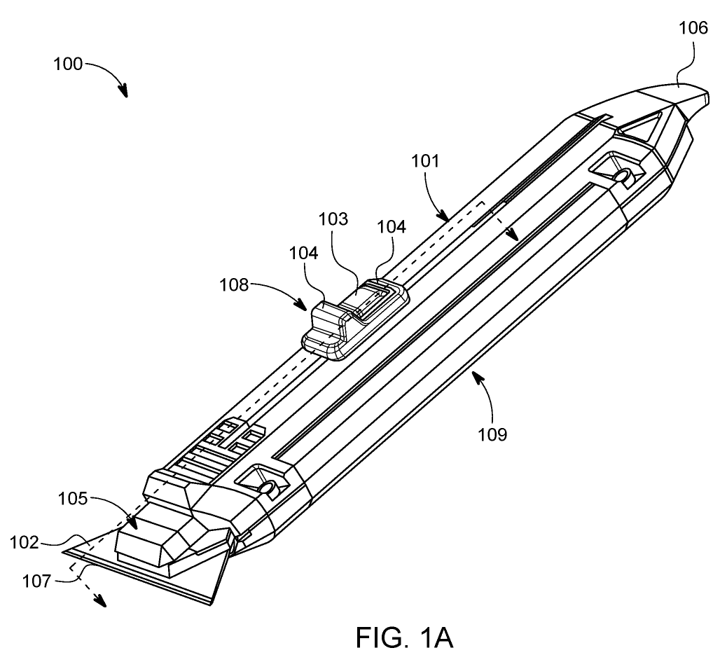

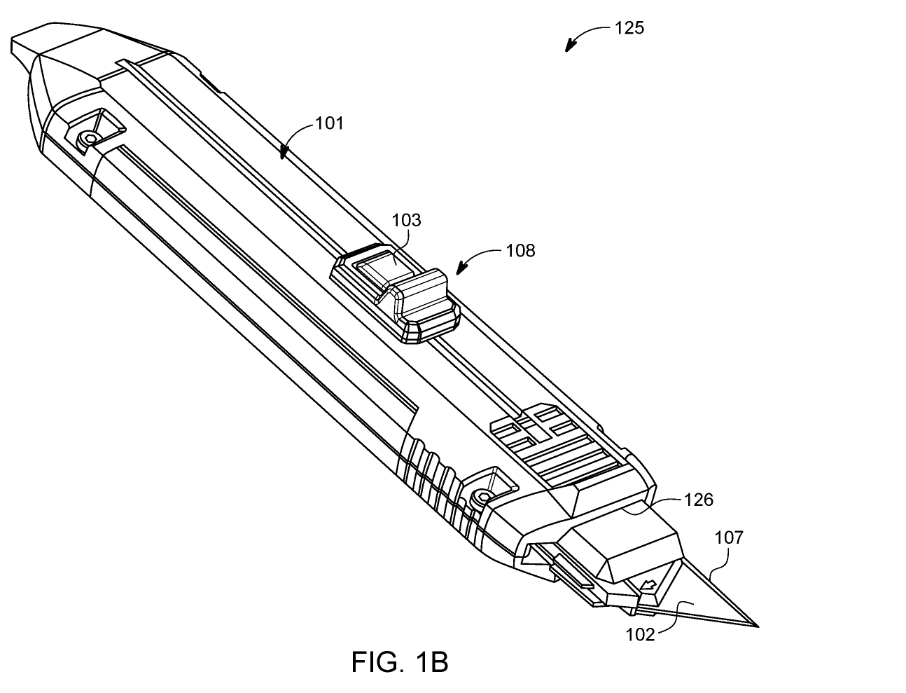

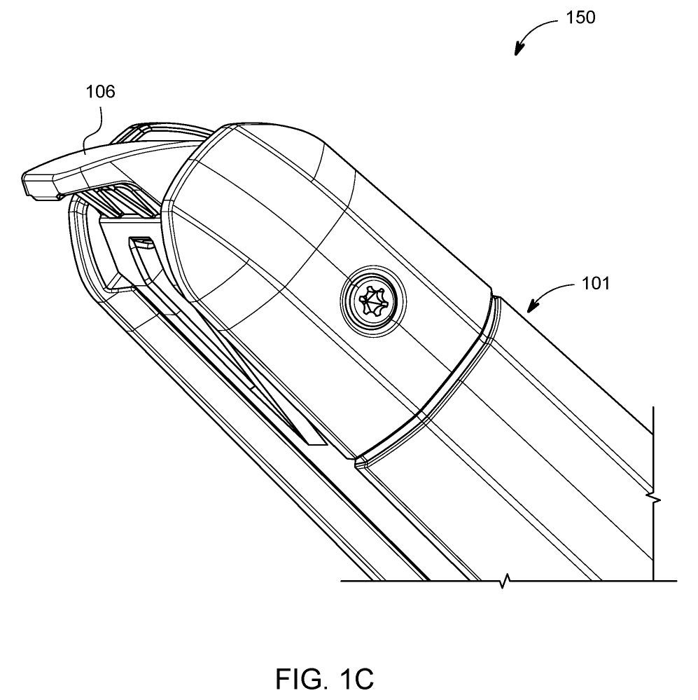

FIG. 1A shows an example view of a convertible knife in a scraping configuration. In various embodiments, the scrapping configuration view 100 includes convertible knife 109, knife housing 101, blade 102, slider assembly 108, slider button 103, slider safety frame 104, blade clamp assembly 105, paint can opener 106, and blade edge 107. Section A-A is also shown.

In various embodiments, the convertible knife 109 may be used in one of two modes of operation at a time. A first mode of operation is the cutting mode, in which the convertible knife 109 is in the knife configuration. A second mode of operation is the scraping mode, in which the convertible knife is in the scraper configuration. The user or operator may switch the convertible knife 109 between the cutting mode and the scraping mode. The conversion between the two modes is performed by an operator by sliding the slider assembly 108 up and down a portion of the length of the convertible knife 109 between a front end of the convertible knife 109, from which the blade 102 emerges and the rear end, at which the paint can opener 106 is attached.

In various embodiments, the blade102 is held in place by a blade clamp assembly 105, a further described below with respect to other figures.

In various embodiments, the slider assembly 108 includes the slider safety frame 104 surrounding the slider button 103. The slider safety frame 104 prevents the slider button 103 from being accidentally depressed under most circumstances.

In some embodiments, the blade clamp assembly 105 may be coupled with a blade

carriage and the slider assembly 108, as further described below with respect to other figures.

In various embodiments, the paint can opener 106 may be coupled with the rear end of the convertible knife 109 and be usable to open a can of paint or be used as small lever to pry open a cap, a lid or other similar edges.

In various embodiments, the knife housing 101 is hollow to contain a sliding blade carriage assembly, described below, and provide internal recesses and edges to control the positioning of the blade carriage assembly.

FIG. 1B shows an example view of the convertible knife of FIG. 1A in a cutting configuration. In various embodiments, the cutting configuration view 125 includes knife housing 101, slider assembly 108, blade 102, blade edge 107, and knife front opening 126.

In various embodiments, the knife blade clamp assembly 105 holding the blade 102, enter and exit the knife housing 101 through the knife front opening 126. When transitioning between the two modes of operation (cutting and scraping), the blade clamp assembly 105 extends outwards from the knife housing 101 through the knife front opening 126, and rotates in the appropriate direction to go from one operational mode to the other, as further described below with respect to other figures. The blade clamp assembly 105 may also be fully retracted into the housing 101 for user safety and also to protect the sharp blade edge 107. In this configuration, the blade 102 and blade clamp assembly 105 are not externally visible.

In various embodiments, the blade edge rotates 90 degrees between the cutting mode and the scraping mode, creating an orthogonal orientation for the knife configuration and the scraper configuration with respect to each other.

FIG. 1C shows an example view of a rear end of the convertible knife of FIGURE lA having a paint can opener. In various embodiments, the paint can opener view 150 includes the knife housing 101 and the paint can opener 106.

In various embodiments, the paint can opener 106 may be a straight bar, while in other embodiments, it may be a curved bar. Still in other embodiments, the paint can opener 106 may be in the form of a hook. Generally, the paint can opener may be in any form that is suitable for prying open a tightly closed pressure-fit lid on a container.

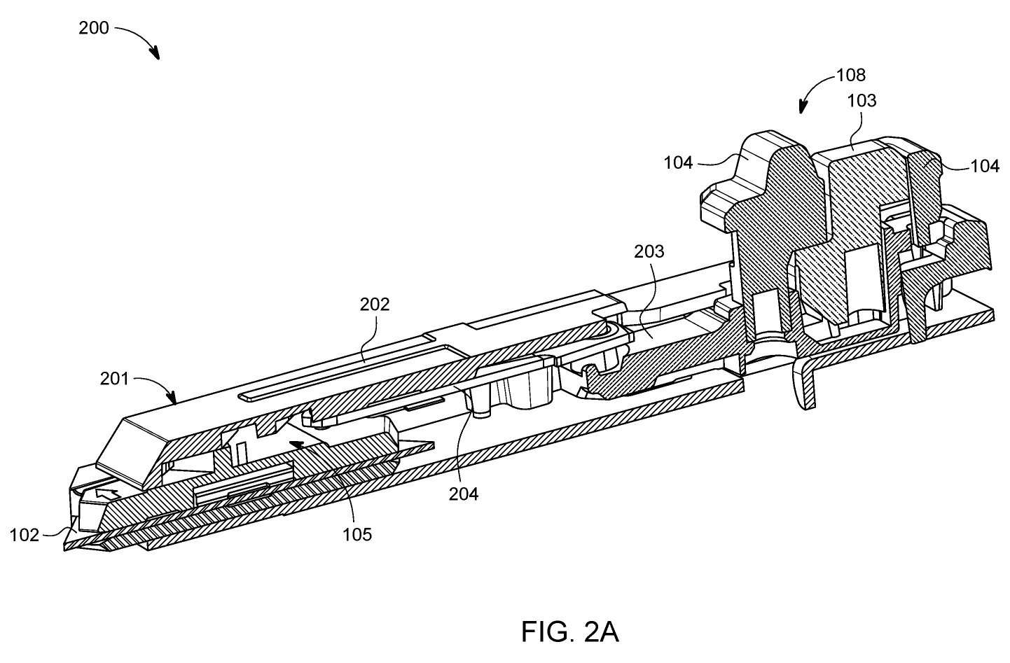

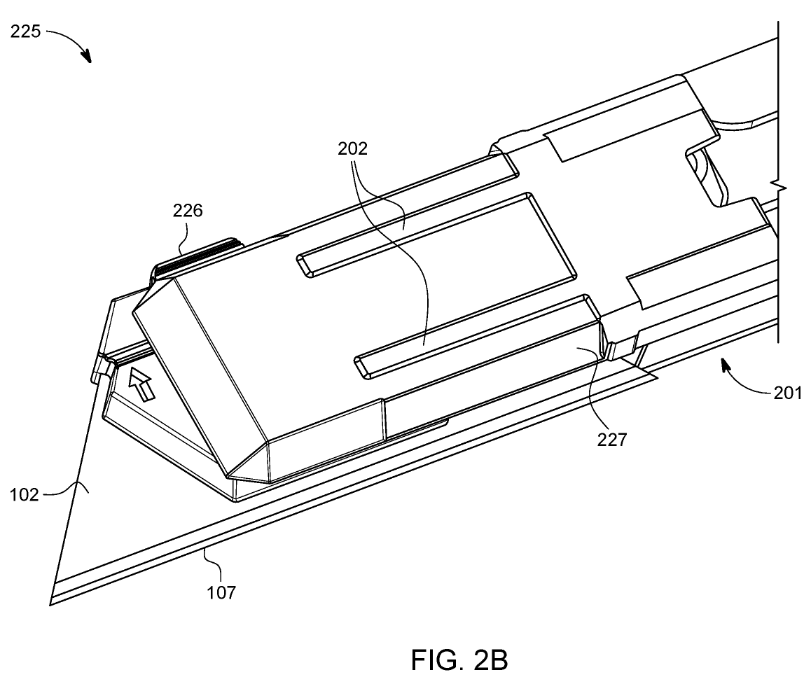

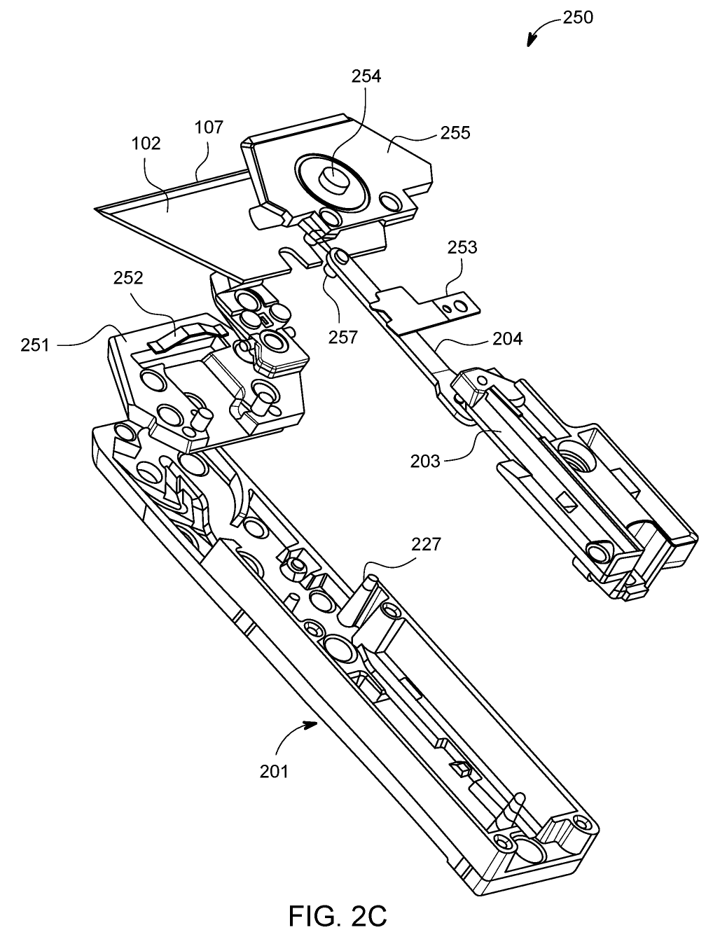

FIG. 2A shows an example cut-away view of a blade carriage assembly deployed within the convertible knife of FIGURE lA. In various embodiments, the blade carriage assembly view 200 includes blade 102, slider button 103, slider safety frame 104, blade clamp assembly 105, slider assembly 108, blade carriage assembly 201, sliding strips 202, slider arm 203, and slider finger 204.

In various embodiments, the blade clamp assembly 105 fits inside the blade carriage assembly 201, and can slide in and out of the blade carriage assembly 201 under user control.

In various embodiments, the blade carriage assembly 201 itself fits and slides part-way within the knife housing 101 by user action using the slider assembly 108. When the user presses slider button 103 and pushes the slider assembly 108 forward (towards the knife front opening 126) within the knife housing 101. The slider arm 203 is also pushed forward, pushing the slider finger 204, which, in turn pushes the blade carriage assembly 201 forward and partially out of the knife housing 101 through the knife front opening 126, until it hits a stop within the knife housing 101, as described below with respect to other figures. At this point, the blade carriage assembly 201 is not moving with respect to the knife housing 101. If the user pushes the slider assembly 108 forward, the slider finger 204 will cause the blade clamp assembly 105 to rotate and shift the operational mode of the convertible knife.

In various embodiments, the user may also use the slider assembly 108 to move the blade carriage 201 completely back into the housing 101, hiding the blade 102 and the blade clamping assembly 105.

In various embodiments, the sliding strips 202 are incorporated into the casing or body of the blade carriage assembly 201, as shown, to reduce the contact surface area between the blade carriage assembly 201 outer surface and the knife housing 101 inner surface. This way, the friction between carriage assembly 201 and the knife housing 101 is reduced during the sliding of the blade carriage assembly 201 to deploy or store the blade 102, or to change the operational mode of the knife.

FIG. 2B shows an example view of the blade carriage assembly in a cutting mode. In various embodiments, the blade carriage assembly view 225 includes the blade carriage 201, the sliding strips 202, the blade 102, the blade edge 107, the blade release button 226, and blade carriage stop 227.

In various embodiments, the sliding strips 202 on the outer surface of the blade carriage assembly 201 reduce friction between the blade carriage assembly 201 and the knife housing 101, during various sliding operations initiated by the user using the sliding assembly 108.

In various embodiments, the blade release button 226 is used to release and/or replace the blade 102, for example, when it becomes dull and a new sharper blade is needed. The user may activate the blade release button 226 by pushing it in a direction parallel to the normal vector that defines the surface plane of the blade 102 while held in the blade clamp assembly 105, and towards the top surface of blade carriage assembly 201 on which the sliding strips 202 are incorporated (in this figure, the button release 226 is pulled up or out from the surface of the paper). This direction is also perpendicular to surface plane of the blade 102.

In various embodiments, blade carriage stop 227 is incorporated into the blade carriage assembly 201 to stop the blade carriage assembly 201 from sliding within the knife housing 101 beyond a certain point defined by a corresponding stop incorporated on the interior of the knife housing101. This way, when the user presses slider button 103 to push the blade carriage assembly 201 forward, the blade carriage assembly 201 is stopped with respect to the knife housing 101 to allow the blade clamp assembly 105 to start rotating and change the mode of operation of the convertible knife 109.

FIG. 2C shows an example exploded view of the blade carriage assembly and a blade in scraper mode. In various embodiments, the exploded view 250 includes the blade carriage assembly 201, blade 102, blade edge 107, slider arm 203, slider finger 204, a blade clamp lower part 251, the blade carriage stop 227, a blade clamp spring 252, a slider finger spring 253, a blade clamp pivot 254, a blade clamp upper part 255, and a slider guide pin 257.

In various embodiments, blade 102 is clamped between the blade clamp lower part 251 and the blade clamp upper part 255, which are coupled with the slider assembly via the slider finger 204 and slider arm 203. The blade clamp assembly 105 and its constituent parts fit within the blade carriage assembly 105, as noted before.

In various embodiments, the blade clamp spring 252 pushes blade 102 up towards the blade clamp upper part 255 to positively engage perforations or holes incorporated within blade 102 with corresponding protrusions incorporated on the blade clamp lower part 251 and blade clamp upper part 255, as further described below with respect to other figures.

In various embodiments, the blade clamp pivot 254 fits within a corresponding pivot hole incorporated in the casing of the blade carriage assembly 201. The blade clamp assembly 105 and blade 102 held by it, rotate around the clamp pivot 254 when transitioning between cutting and scraping modes.

In various embodiments, the slider finger spring 253 serves to stabilize the slider finger 204 and prevent its buckling or bending when pushed by the slider arm 203, by pressing the slider finger 204 against the interior wall of the case of the blade carriage assembly 201.

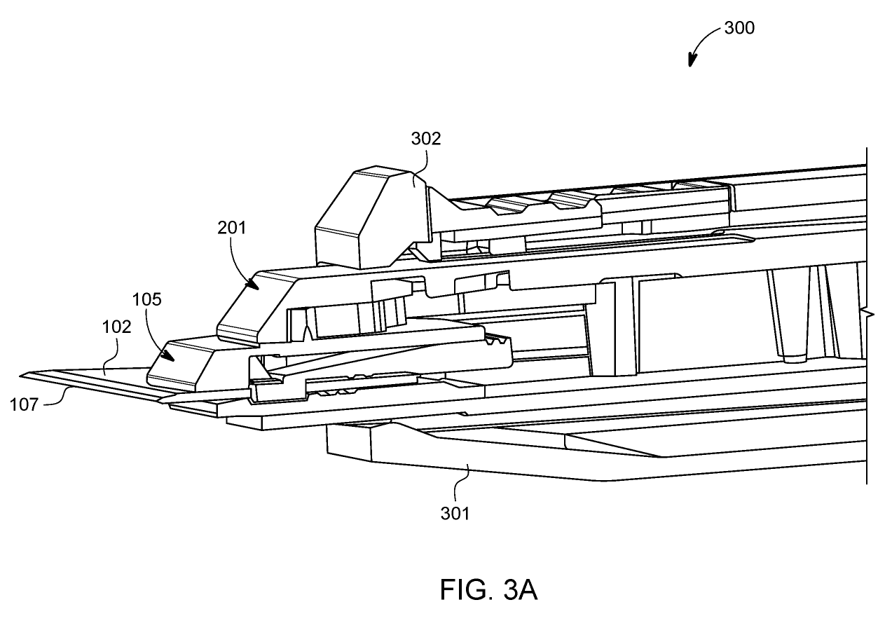

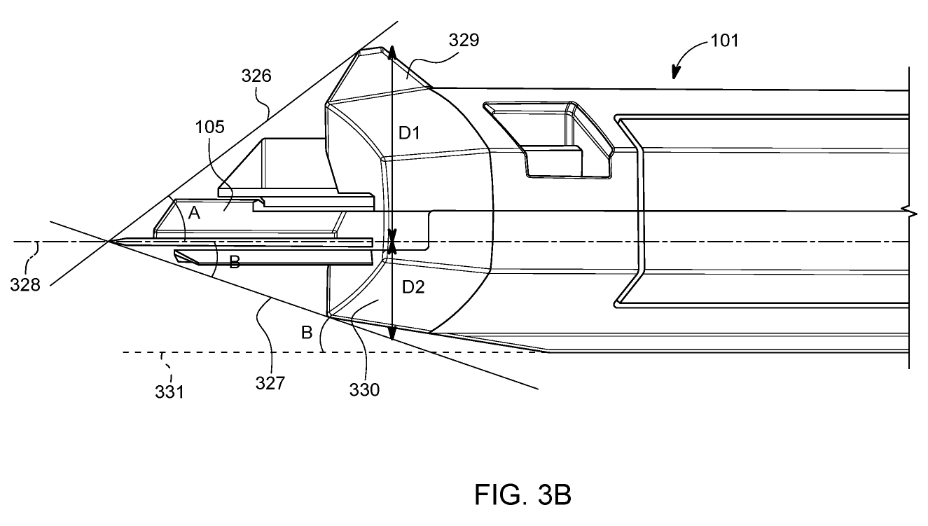

FIG. 3A shows an example cut-away view of the convertible knife of FIGURE lA in the scraping configuration. In various embodiments, the cut-away view 300 includes section A-A of FIGURE lA, blade 102, blade edge 107, blade clamp assembly 105, blade carriage assembly 201, housing bottom part 301 of knife housing 101, and housing top part 302, through which the slider assembly 108 is made available to the user.

In various embodiments, the different layers shown in this figure brace the blade 102 from all directions, top and bottom and both sides, to keep the blade 102 firmly in place during cutting and scraping. The structural support provided by the knife housing 101, blade carriage assembly 201, and blade clamp assembly 105, create a robust and stable knife assembly to handle intensive cutting and scraping jobs. The forces imparted on the blade 102 and/or blade edge 107 during cutting and scraping may include push and pull forces along a longitudinal axis of the knife housing 101 extending from the knife front opening 126 to the rear end of the knife housing 101 where the paint can opener 106 is located. Additional forces may be imparted on the blade 102 in a direction from one exposed pointed corner (on the side of the cutting blade edge 107) of the blade 102 to the other corner, particularly when corners of the blade are used in cutting or scraping in an asymmetrical way (with respect to a centerline or center point of the blade 102).

Also, moment forces or torques may be created in various directions and about various geometric axis of the blade 102 by applying asymmetrical motions and forces by the user during cutting and scraping. The aforementioned support structures resist these imparted forces and torques in various directions by fully and firmly surrounding the blade 102. For example, during cutting, in which a sharp corner and edge of the blade 102 is used, a torque is created between the user's hand holding the knife housing 101 and the blade corner pushing against the work surface. This torque tends to rotate the blade about its center normal vector of the surface of the blade. This torque is resisted by the pins in the top notches and center trapezoidal perforation (described further below with respect to other figures) of the blade 102. The structural supports are further described below with respect to other figures.

FIG. 3B shows an example side view of the convertible knife of FIG. 1A. In various embodiments, side view 325 incudes knife housing 101, blade clamp assembly 105, upper tip slope 326 of convertible knife, lower tip slope 327, blade centerline 328, upper slope angle A, lower slope angle B, upper distance 329 (D1) from housing top part 302 to blade centerline 328, lower distance 330 (D2) from housing bottom part 301 to blade centerline 328, and scraping surface 331.

In various embodiments, the upper angle A is greater than the lower angle B and the upper distance D1 is greater than the lower distance D2, creating smaller scraping angle when the convertible knife 109 is in the scraping mode. In the cutting mode, this configuration does not alter the cutting angle of the blade or handling of the knife. With this asymmetrical configuration the upper angle A is greater than lower angle B, making the lower angle B smaller than a symmetrical configuration (by basic geometry, lower angle B between lower slope 327 and blade centerline 328 is equal to the angle between lower slope 327 and the surface being scraped 331), the scraping blade scrapes closer to parallel to the scraping surface 331 and removes more stains or contaminants, like paint or gum, from the scraping surface 331.

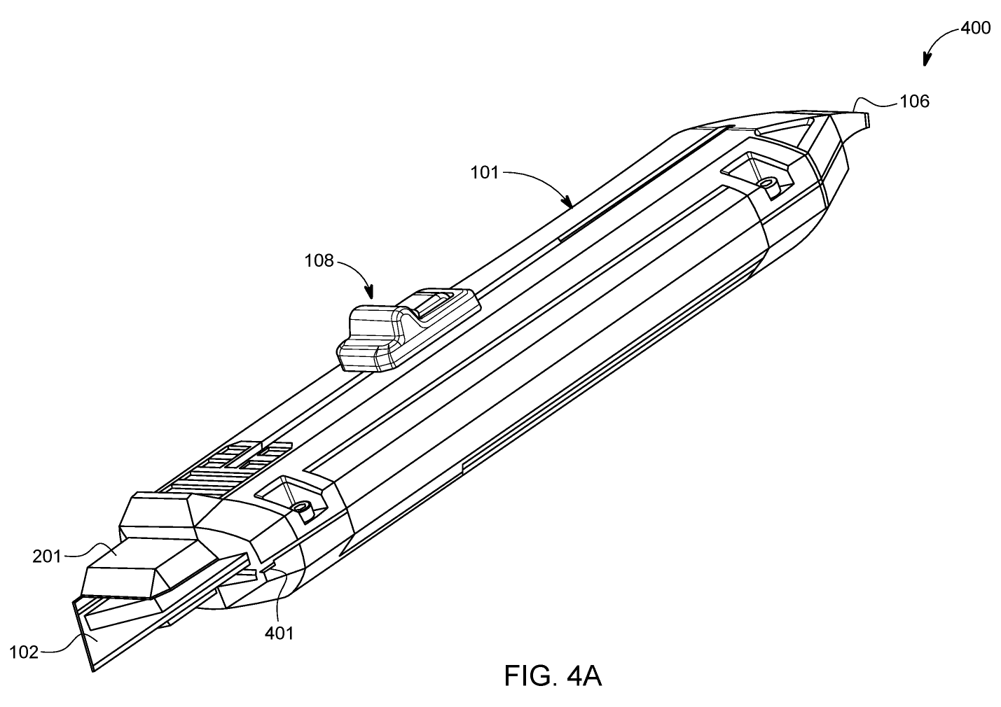

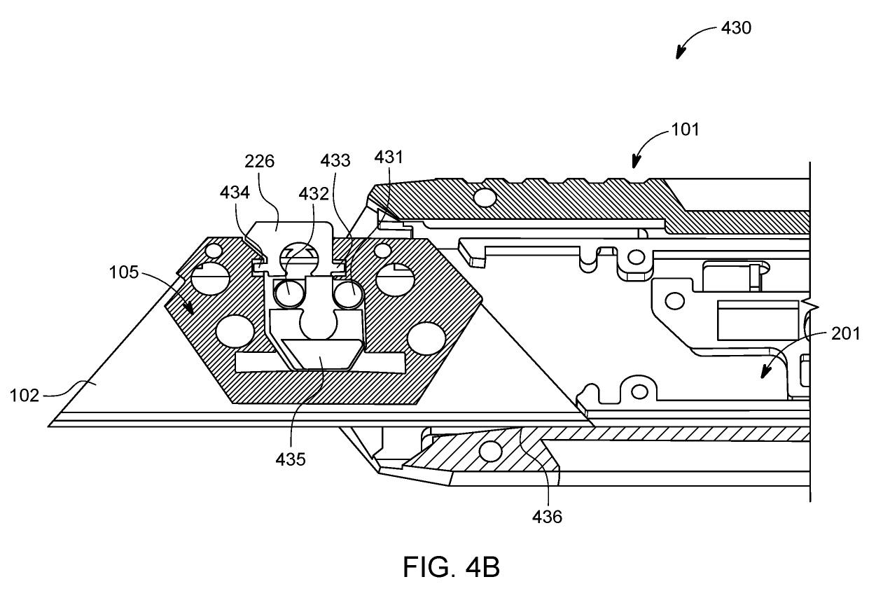

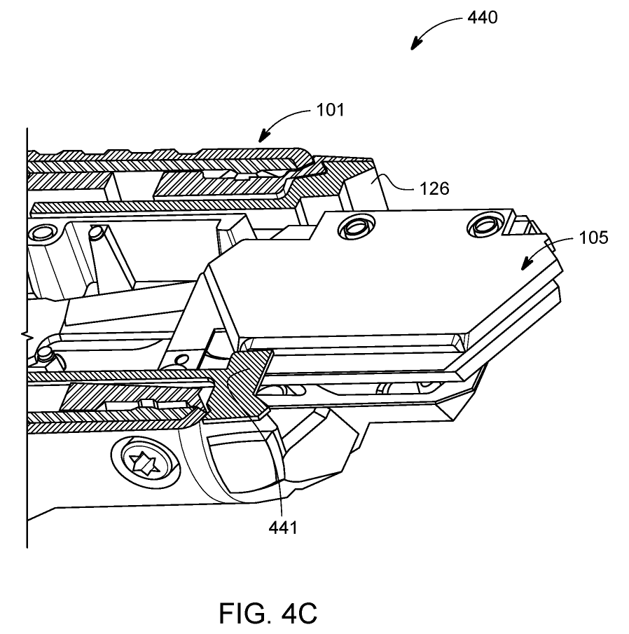

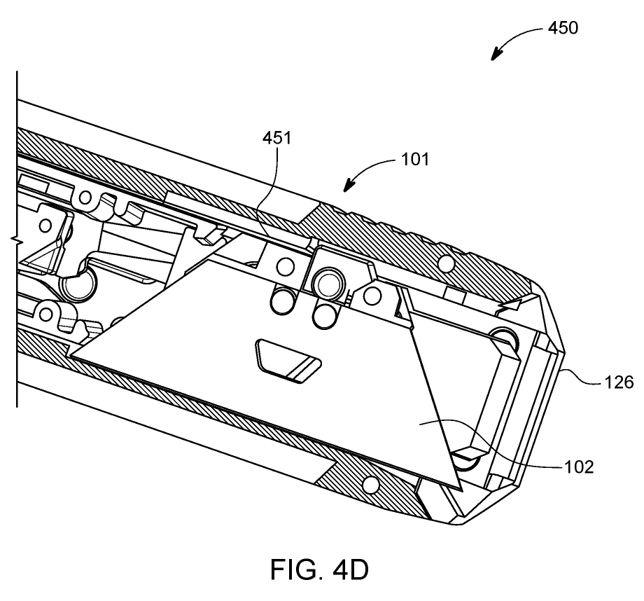

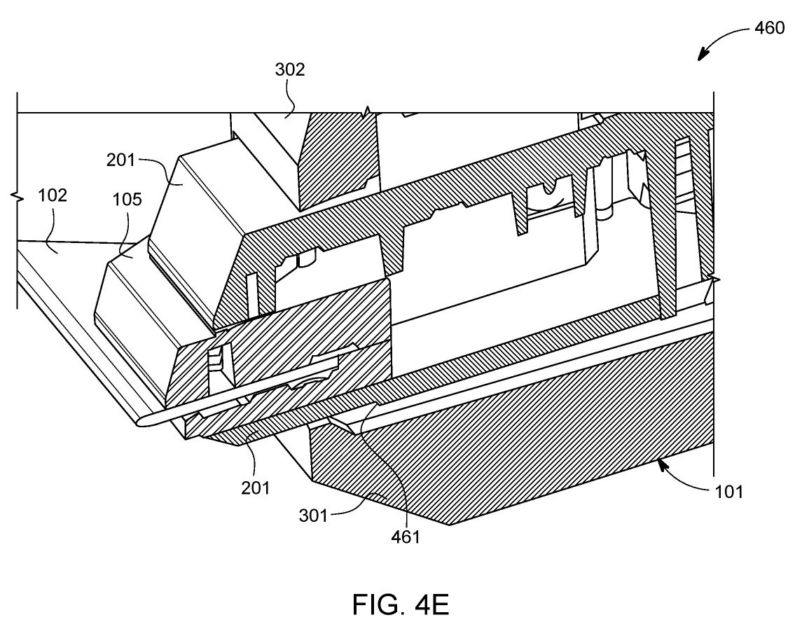

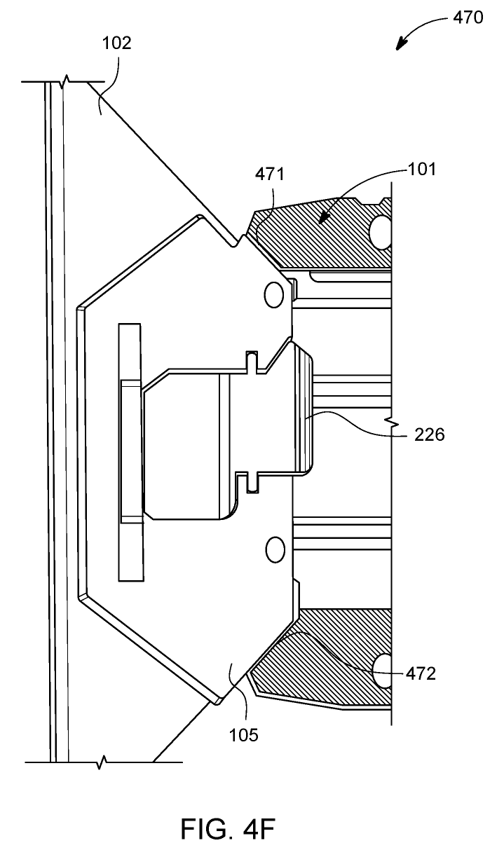

FIG. 4A shows an example view of the convertible knife of FIG. 1B with blade rotation slot in a housing of the convertible knife. In various embodiments, the view 400 includes knife housing 101, blade 102, paint can opener 106, slider assembly 108, blade carriage assembly 201, and blade rotation slot 401.

In various embodiments, as described above with respect to FIG. 2A, the blade carriage assembly 201 may be at different points within and along the length of the knife housing 101 based on user actions. When the user presses the slider button 103 to move the slider assembly 108 forward in the knife housing 101, the blade carriage assembly 201 is moved forward also until it stops and allows the blade clamp assembly 105 to continue moving forward with respect the knife housing 101 for transition from one mode to another. The transition between modes (cutting and scraping modes) is implemented by a rotation of the blade clamp assembly 105. To allow rotation, the blade clamp assembly 105 has to be moved forward sufficiently to allow the blade 102 to clear the knife housing 101 walls and internal cavity. The blade rotation slot 401 accommodates the rotation of the blade clamp assembly 105 by allowing the blade 102 start rotating before being completely out of the knife housing 101 through knife front opening 126.

In various embodiments, a rear end (opposite the blade end) of the blade carriage assembly 201 is coupled with a carriage spring (not shown), which is in turn coupled with the rear end of the knife housing 101, near the paint can opener 106. When the user presses the slider button 103 and pushes the blade carriage assembly 201 forward, the carriage spring is also pulled forward and extended. On release of the slider button 103, the carriage spring pulls the blade carriage assembly 201 backwards until it settles in a recess in the knife housing 101. This way, the user generally pushes the slider assembly 108 forward and let the carriage spring pull it backwards. In other embodiments, the carriage spring is not used or included in the knife housing 101, and the user pushes the slider assembly 108 forwards and backwards manually by pressing the slider button 103. In either embodiment, the user has the option to manually move the slider assembly 108 forwards and backwards.

FIG. 4B shows an example cut-away view of the convertible knife of FIG. 1B in the cutting configuration. In various embodiments, the cut-away view 430 includes knife housing 101, blade 102, blade clamp assembly 105, blade carriage assembly 201, blade release button 226, a first blade pin 431, a second blade pin 432, a first release pivot end 433, a second release pivot end 434, a trapezoidal pin 435, and a lower housing wall 436.

In various embodiments, blade 102 is held securely within the blade clamp assembly 105 by the mating of the blade perforations with the corresponding protrusions incorporated in the clamp assembly 105. More specifically, some razor blades, like blade 102, have two perforations or notches on a non-cutting, top edge of the blade (opposite side from sharp cutting blade edge 107) that fit two corresponding pins in common existing box cutter knives to hold the blade securely. However, in scraping mode, scraping forces applied to the blade edge 107 create forces and/or moments (force couples that cause rotation of a rigid body) with respect to the top notches of the blade that may be sufficient to displace the blade 102 from the blade holder of the existing scrapers (similar in function to blade clamp assembly 105). The moments created may serve to rotate the blade around various axis of rotation, thus tending to displace or twist and deform the blade. As known in the mechanical arts, a moment is a rotational force, also known as a couple, that is created by two separate forces separated by a distance, called moment arm, that tend to rotate the rigid body on which they act, such as the action of a wrench or screwdriver on a screw head. By adding a third perforations in the form of a trapezoid with a trapezoidal protrusion or pin 435, the forces and moments created from scraping forces acting on all points of the blade edge 107, including center portions and corners, are resisted and nullified, keeping the blade 102 firmly in place. The sides of the trapezoidal pin 435 are straight and resist rotation, unlike a round or curved pin inserted in a hole or notch. In other embodiments, the trapezoidal pin 435 and its receiving perforation, may be designed to have other shapes, such as a rectangle, a square, or an irregular or regular shape that has straight edges or asymmetrical edges or corners that resist moments in various rotational directions.

In various embodiments, the top notches of the blade 102 are engaged and held in place by first and second blade pins 431 and 432, and the trapezoidal perforations is similarly engaged by the trapezoidal pin 435. To release the blade from the blade clamp assembly 105, the blade release button 226 is actuated by the user when the blade clamp assembly 105 is partially out of the knife housing 101, for example, when in the cutting mode. The blade release button 226 rotates about the first and second release pivot ends 433 and 434. This motion causes the blade pins 431, 432, and 435 to be extracted from their corresponding receiving perforations and release blade 102 for removal and replacement by the user.

In various embodiments, the blade release button 226 is accessible to the user in the knife configuration (cutting mode) and is not accessible in the scraper configuration (scraping mode). When in the cutting mode, the blade release button 226 is visible and accessible to the user since it is located opposite the blade edge 107, as shown in this figure. When in the scraping mode, the blade release button rotates with the blade and is hidden inside the knife housing 101 and is not accessible to the user, as shown in at least FIGURE lA and other figures described below. In the scraping mode, the blade edge 107 is outside the housing 107, while the blade release button 226, which is still located opposite the blade edge 107, has rotated into the knife housing 101 and is no longer accessible to the user. Similarly, when the blade clamp assembly 105 is retracted by the user to be completely within the knife housing 101, the blade release button 226 is hidden and is not user-accessible. In these configurations, the blade release button 226 is not visible or accessible to the user to provide a safety feature and prevent accidental release of the blade 102 during usage or transportation.

In various embodiments, the lower housing wall 436 is touching the blade 102, preventing the blade from rotating downwards (same direction as the blade edge 107 is pointing). This action of the lower housing wall 436 is created when the convertible knife 109 is in the cutting mode.

In various embodiments, the blade clamp assembly 105 covers or encloses a limited portion of the blade 102, of approximately the center one-third (1/3), with a variation of plus or minus about 10%, of the blade 102 next to the cutting blade edge 107, without covering the cutting edge as shown in FIG. 4B, leaving the two sharp pointed corners of the blade 102, one at each of the two ends of the blade sharp edge, exposed to a greater extent for better and deeper scraping and cutting. This configuration is in contrast to a configuration in which the blade clamp assembly 105 extends its coverage of the blade 102 to near the sharp pointed corners of the blade 102, leaving significantly less than one-third of each of the pointed corners of the blade 102 exposed.

FIG. 4C shows an example cut-away view of the convertible knife of FIG. 1A, with a blade clamp assembly. In various embodiments, the cut-away view 440 includes knife housing 101, blade clamp assembly 105 without a blade inserted, knife front opening 126, and blade clamp lower stop 441.

In various embodiments, the blade clamp lower stop 441 prevents blade clamp assembly 105 from rotating by butting against the bottom edge of the blade clamp assembly 105, as shown, when the blade clamp assembly 105 is not holding a blade. The blade clamp lower stop 441 may also provide additional structural support around the blade clamp assembly 105 to further prevent it from moving or rattling during extended use and over its lifetime.

FIG. 4D shows an example cut-away view of the convertible knife of FIG. 1B, with the blade in a retracted state. In various embodiments, the cut-away view 450 includes knife housing 101, blade 102, knife front opening 126, and blade clamp upper stop 451.

In various embodiments, the blade clamp upper stop 451 prevents blade clamp assembly 105 from rotating by butting against the bottom edge of the blade clamp assembly 105, as shown, when blade assembly 105 is fully retracted inside the knife housing 101. The blade clamp upper stop 451 may also provide additional structural support around the blade clamp assembly 105 to further prevent it from moving or rattling during extended use and over its lifetime.

FIG. 4E shows an example cut-away view of the convertible knife of FIG. 1A, with top and bottom structural support for the blade. In various embodiments, the cut-away view 460 includes knife housing 101, blade 102, blade clamp assembly 105, blade carriage assembly 201, housing bottom part 301, housing top part 302, and housing carriage stop 461.

In various embodiments, various structural and rigid layers surround the blade 102 to support and keep it firmly in place during usage. More specifically, the housing bottom part 301, the housing top part 302, the blade carriage assembly 201, and the blade clamp assembly 105 form rigid layers around the blade 102 to keep it firmly in place during cutting and/or scraping.

In various embodiments, blade carriage stop 227 (see FIG. 2B) hits the housing carriage stop 461 when the blade carriage assembly 201 is moving forward. The housing carriage stop 461 determines the extent of blade carriage assembly 201 motion forward. As noted earlier, blade carriage stop 227 is incorporated into the blade carriage assembly 201 to stop the blade carriage assembly 201 from sliding within the knife housing 101 beyond the point determined by the housing carriage stop 461 incorporated on the interior of the knife housing101. This way, when the user moves the slider assembly 108 to push the blade carriage assembly 201 forward, the blade carriage assembly 201 hits the housing carriage stop 461 and is stopped with respect to the knife housing 101. This halted motion of the blade carriage assembly 201 allows the blade clamp assembly 105 to start rotating and change the mode of operation of the convertible knife 109.

FIG. 4F shows an example cut-away view of the convertible knife of FIG. 1A, with side structural support for the blade. In various embodiments, the cut-away view 470 includes knife housing 101, blade 102, blade clamp assembly 105, a first side support 471, and a second side support 472.

In various embodiments, in the scraping mode, the blade clamp assembly 105 is surrounded by the two side supports 471 and 472 incorporated in the knife housing 101 to physically and structurally support the blade clamp assembly on its sides and prevent it from moving side to side.

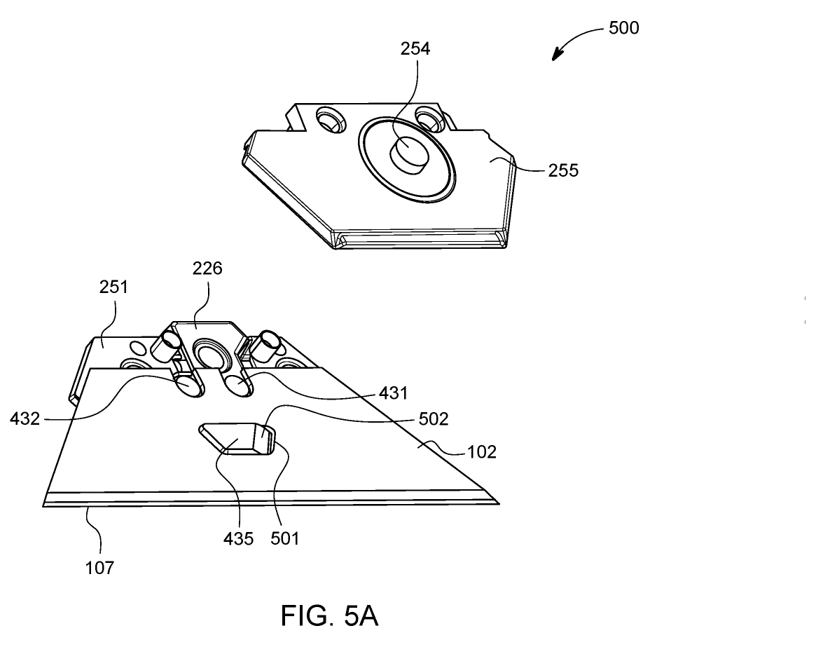

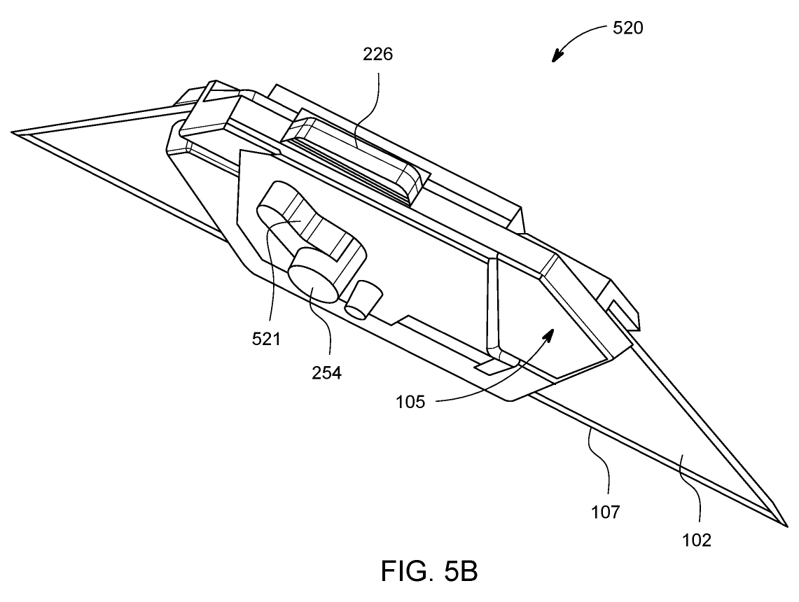

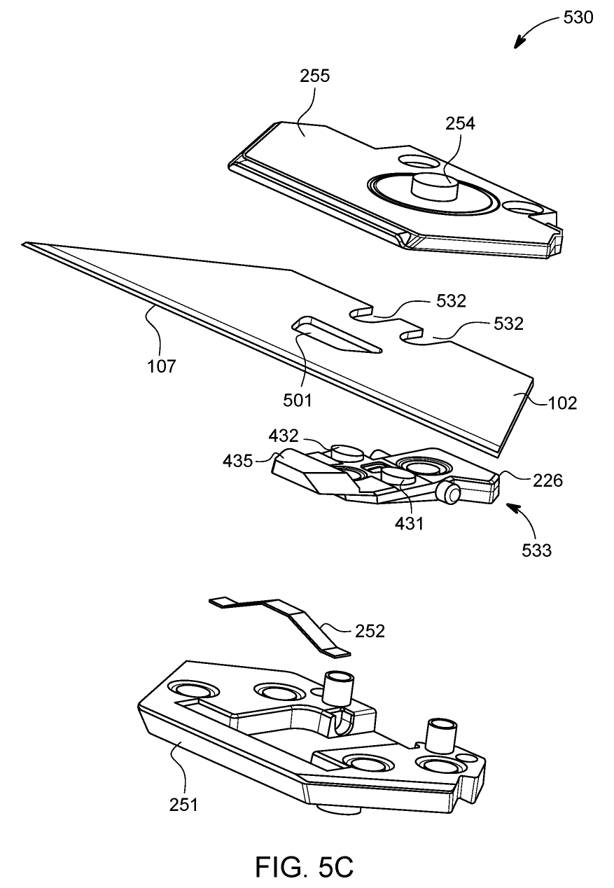

FIG. 5A shows an example exploded view of the blade clamp assembly. In various embodiments, the exploded view 500 includes the blade 102, blade edge 107, blade release 226, blade clamp lower part 251, blade clamp pivot 254, blade clamp upper part 255, first blade pin 431, second blade pin 432, trapezoidal pin 435, trapezoidal central perforation 501, and trapezoidal pin ramp 502.

In various embodiments, the blade 102 is sandwiched between the blade clamp lower part 251 and blade clamp upper part 255, while also being secured by the first blade pin 431, second blade pin 432, and trapezoidal pin 435 inserted into the trapezoidal central perforation 501 to keep the blade 102 firmly held in place.

In various embodiments, the blade clamp pivot 254 fits in a hole incorporated in the blade carriage assembly 201, about which the blade clamp assembly 105 can rotate to change operational mode.

In various embodiments, the trapezoidal pin 435 has a slanted side or ramp 502, which may make it easier to remove the blade without binding on the trapezoidal pin 435 by sliding up the ramp 502 when the blade 102 is pulled forward by the user to remove it. The location of the ramp 502 is on the rear-facing side (towards the paint can opener 106) of the trapezoidal pin 435. The blade is pulled off from the blade clamp assembly towards the front of the convertible knife 109. Hence, the edge of the trapezoidal central perforation 501 slides up the ramp 502 when pulled forward for removal.

In various embodiments, the trapezoidal pin 435 may have other geometric or irregular shapes, such as square, rectangular, oval, triangular, star-shaped, and the like, with a central perforation 501 shape that matches the pin shape. In some embodiments, two pins, instead of three pins, may be employed, one on top of the blade 102 (opposite the sharp edge) and one at the central perforation 501 to keep the blade from rotating.

FIG. 5B shows another example top view of the blade clamp assembly. In various embodiments, view 520 includes blade 102, blade clamp assembly 105, blade edge 107, blade release button 226, blade clamp pivot 254, and blade rotation bar 521.

In various embodiments, the blade clamp assembly 105 may be rotated by pushing and turning the blade rotation bar 521 in the appropriate direction. The blade rotation bar may be rigidly integrated with the blade clamp assembly 105, so that rotation of one causes the rotation of the other.

FIG. 5C shows an example exploded view of the blade clamp assembly. In various embodiments, the exploded view 530 includes blade 102, blade edge 107, blade clamp lower part 251, blade clamp upper part 255, blade clamp pivot 254, blade release button 226, blade clamp spring 252, first blade pin 431, second blade pin 432, blade trapezoidal pin 435, blade trapezoidal perforation 501, blade top notches 532, and blade release assembly 533.

In various embodiments, blade 102 is enclosed within the blade clamp upper part 255 and blade clamp lower part 251, while blade clamp spring 252 pushes and biases the blade 102 against the blade clamp upper part 255. The blade release assembly 533 includes the first and second blade pins 431 and 432, respectively, and the trapezoidal pin 435, all of which engage their corresponding perforations on the blade 102. Namely, the first and second blade pins 431 and 432, respectively, are inserted into the top notches 532 of the blade 102, and the trapezoidal pin 435 is inserted into the trapezoidal perforation 501 to keep the blade 102 firmly in place within the blade clamp assembly 105. In some embodiments, the trapezoidal perforation 501 may be located on or near the central area of the blade 102, as shown in the figure. In some embodiments, trapezoidal pin 435 and trapezoidal perforation 501 may have shapes other than trapezoidal, such as star-shaped, rectangular, irregular or any other suitable shape that is able to hold the blade securely within the blade clamp assembly 105.

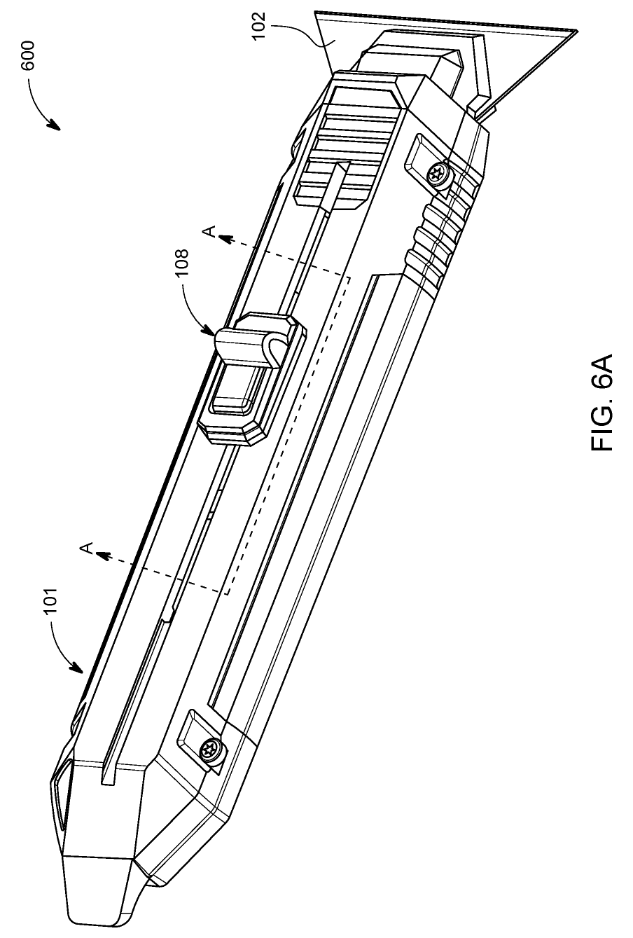

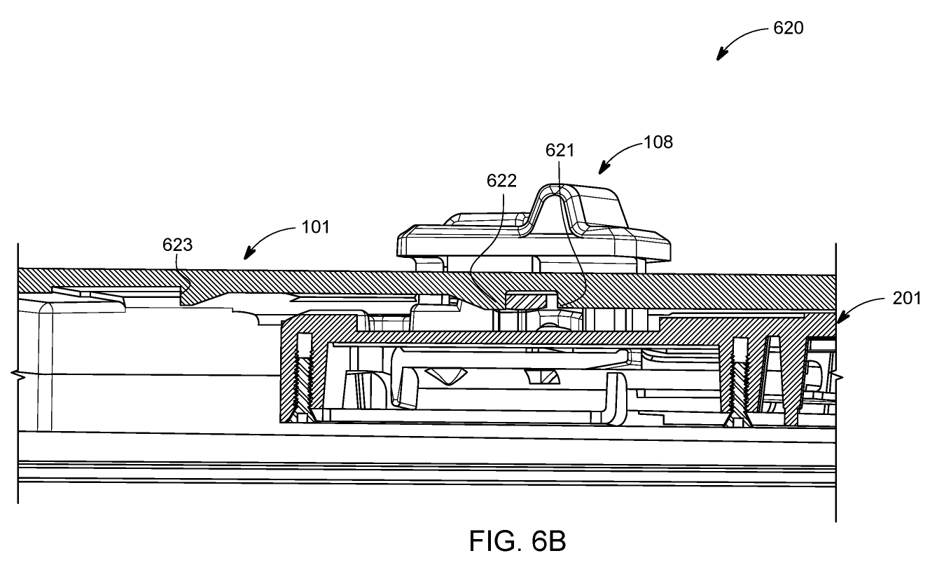

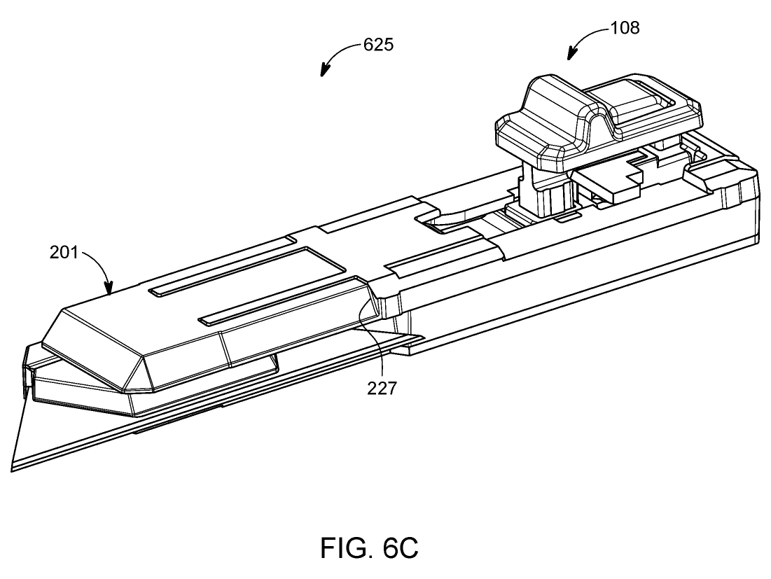

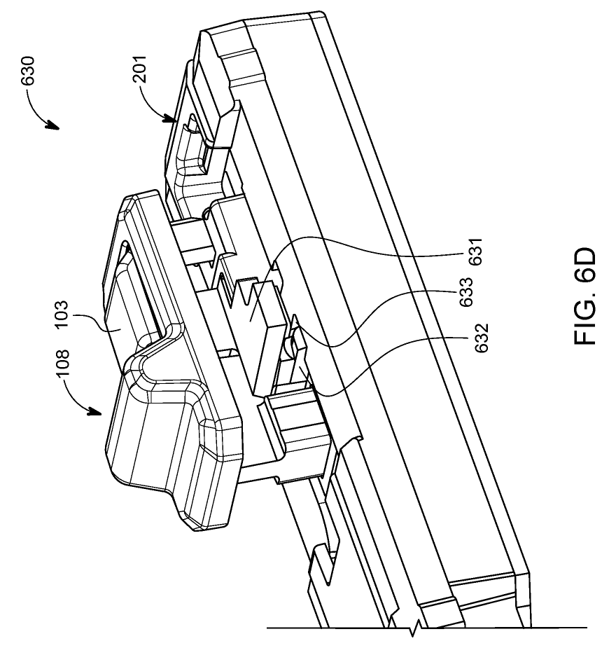

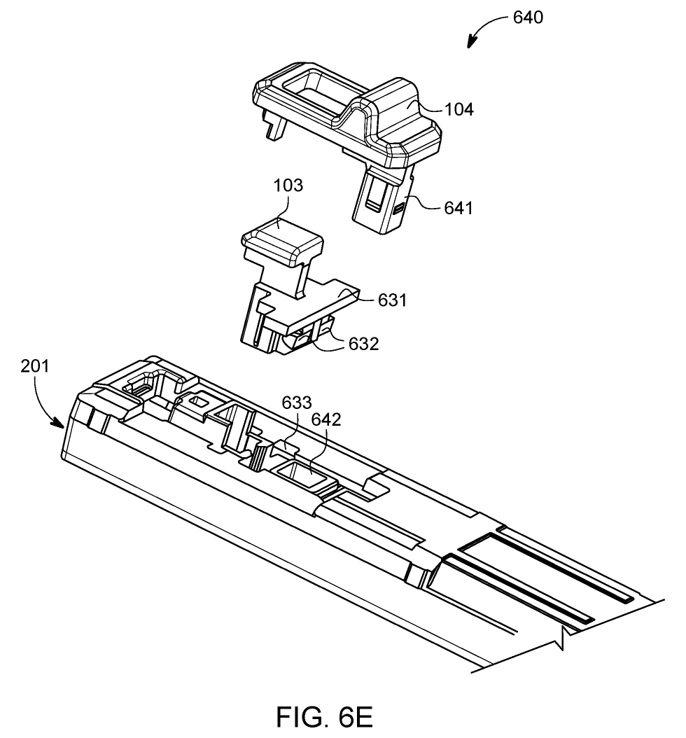

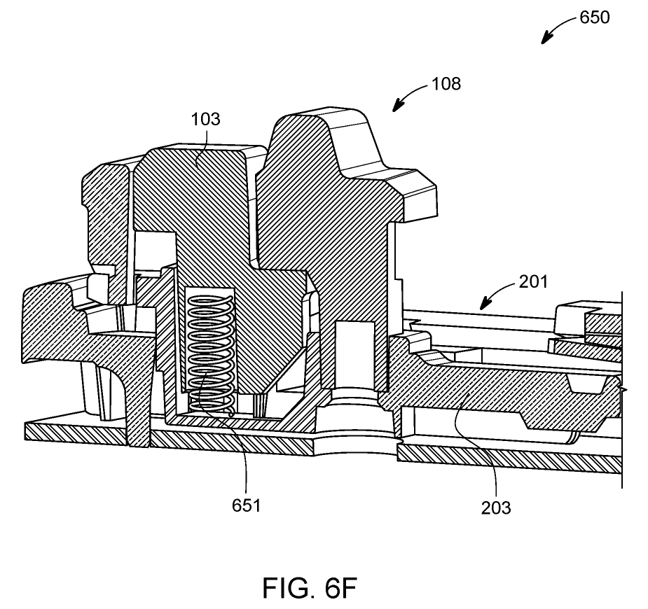

FIG. 6A shows an example view of the convertible knife of FIG. 1A identifying a cross-section A-A. In various embodiments, view 600 includes the knife housing 101, blade 102, slider assembly 108, and section A-A.

In various embodiments, view 600 shows the convertible knife 109 in the scraping mode. The details in section A-A are described below with respect to other figures.

FIG. 6B shows the example cross-section A-A of FIG. 6A. In various embodiments, the cross-sectional view 620 includes knife housing 101, slider assembly 108, blade carriage assembly 201, knife housing recess 621, first slider stop 623, and second slider stop 622.

In various embodiments, the knife housing 101 may include multiple recesses incorporated internally within its walls to stop the slider assembly 108 and/or the blade carriage assembly 201 from sliding further than certain points under user control. Generally, these recesses stop the slider assembly 108 and/or the blade carriage assembly 201 from moving within the knife housing 101 unless the user is pressing and holding the slider button 103 to push the slider assembly 108 and the blade carriage assembly 201 in a forward or rearward direction. The slider button 103 is attached to or integrated with detents that fall into these recesses that are built into the interior of the knife housing 101, when the slider button 103 is not depressed by the user. In some operations, such as change of operational mode, the blade carriage assembly stops at the end of its travel within the housing 101, even when slider button 103 is pressed by the user, to allow further movement of slider by the user to effect the rotation of the blade carriage assembly 201.

In various embodiments, in operation, when the blade carriage assembly is fully retracted into the knife housing 101, the user may press the slider button 103 to start the slider assembly 108 moving forward. Initially the slider assembly 108 pushes the blade carriage assembly 201 and the coupled blade clamp assembly 105 to also move forward. Past a certain point, where the blade carriage stop 227 and housing carriage stop 461 (see FIG. 4E) engage each other and collide. At this point, the blade carriage assembly 201 stops moving with respect to the knife housing 101, but the blade clamp assembly continues to be pushed forward by the slider arm 203 and slider finger 204 (see FIG. 2C) until the blade clamp assembly 105 start rotating to convert from one mode of operation to the other (cutting mode and scraping mode). A s similar process and operation applies in reverse to retract the blade clamp assembly 105 into the knife housing 101. To retract the blade clamp assembly 105, the knife is first placed in the cutting mode to allow it to fit in and slide into the knife housing 101 for storage.

In various embodiments, the interior of the knife housing 101 provides three stops for three predetermined positions of blade carriage assembly 201 within the knife housing 101. The three positions of the blade carriage assembly 201 correspond with three positions of the slider assembly 108. Detents attached to the slider button 103 engage the stops, described below with respect to FIGS. 6D and 6E. The fully retracted position, in which the blade carriage assembly 201 is hidden inside the hollow knife housing 101, is the first slider stop 623. The detents engage the slider stop 623 to stop the blade carriage assembly 201 at this position. When the slider button 103 is pressed, the first slider stop 623 is bypassed and the slider assembly 108 and the blade carriage assembly 201 slide forward within the knife housing 101 to the second slider stop 622, enclosing the knife housing recess 621. Once the slider button 103 is released, the detents engage the second slider stop 622 and the knife housing recess 621, holding the blade carriage assembly in the second position. In this position, the blade is outside knife housing and is in cutting mode. When the slider button 103 is pressed again, the second slider stop 622 is bypassed and slider assembly 108 and the blade carriage assembly 201 slide forward to the third position with housing carriage stop 461 (see FIG. 4E). At this point, an edge of the blade carriage assembly 201, described below with respect to FIG. 6C, engages the housing carriage stop 461 to allow rotation of the blade clamp assembly 105, as described later.

FIG. 6C shows an example view of the blade carriage assembly with blade carriage stop. In various embodiments, the view 625 includes the blade carriage assembly 201, slider assembly 108, and blade carriage stop 227.

In various embodiments, the blade carriage assembly 201 is moved forward (or backward) by user action pressing the slider button 103. The details of the rotation operations of the blade clamp assembly 105 are described below with respect to other figures.

FIG. 6D shows an example view of the blade carriage assembly of FIG. 6C with a blade pull stop tab. In various embodiments, the view 630 includes slider assembly 108, slider button 103, blade carriage assembly 201, a housing detent 631, a carriage detent 632, and a blade carriage recess 633.

In various embodiments, the slider button 103 is integrated with housing detent 631 and carriage detent 632. Each of these detents function to restrict the motion of the slider assembly within the knife housing 101. The housing detent 631 is directly connected to the slider button 103, which when depressed by the user also causes the housing detent 631 to be pushed down clearing the knife housing recesses 621 (see FIG. 6B) and allowing the blade carriage assembly 201 to slide within the knife housing 101. The carriage detent 632 fits inside the carriage recess 633 and restricts the movement of the slider assembly 108 with respect to the blade carriage assembly 201. The carriage detent 632 couples the slider assembly 108 to the blade carriage assembly 201, which performs two distinct functions. One function is to push the blade assembly 201 forward and backward, along with the slider assembly 108, when the slider button 103 is depressed. The other function is to prevent the blade carriage assembly 201 from sliding forward or backward with respect to knife housing 101, when the slider button 103 is not depressed. The latter function also prevents the blade carriage assembly 201 from moving forward during the cutting mode, when the blade 102 is being pulled in a direction that moving out and away and out from the knife front opening 126.

FIG. 6E shows an example cut-away exploded view of the blade carriage assembly of FIG. 6C with slider button stops. In various embodiments, the cut-away exploded view 640 includes the slider safety frame 104, the slider button 103, blade carriage assembly 201, housing detent 631, carriage detent 632, a safety frame coupling 641, and a safety frame receiver 642.

In various embodiments, the slider assembly 108, including the slider safety frame 104 and the slider button 103, is coupled with the blade carriage assembly 201 via two different couplings. The slider button 103 is coupled with the blade carriage assembly 201 via carriage detents 632 that fits inside the carriage recess 633, while the slider safety frame 104 is coupled via the safety frame coupling 641 that fits inside the safety frame receiver 642. When the slider button 103 is depressed by the user, the carriage detents 631 are decoupled from the knife housing 101 to allow the blade carriage assembly 201 to start sliding. The force of the user's finger or thumb on the slider assembly 108 is transferred to the blade carriage assembly 201 via the carriage detents 632 and the safety frame coupling 641 to move the blade carriage assembly 201.

FIG. 6F shows an example cut-away view of a slider assembly coupled with the blade carriage assembly. In various embodiments, the cut-away view 650 includes the blade carriage assembly 201, the slider assembly 108, the slider button 103, the slider arm 203, and the slider button return spring 651.

In various embodiments, when the user depresses the slider button 103, the slider button return spring 651 is also depressed. When the user releases the slider button 103, the slider button return spring 651 causes the slider button 103 to return to its default or undepressed position, ready for another depression by the user.

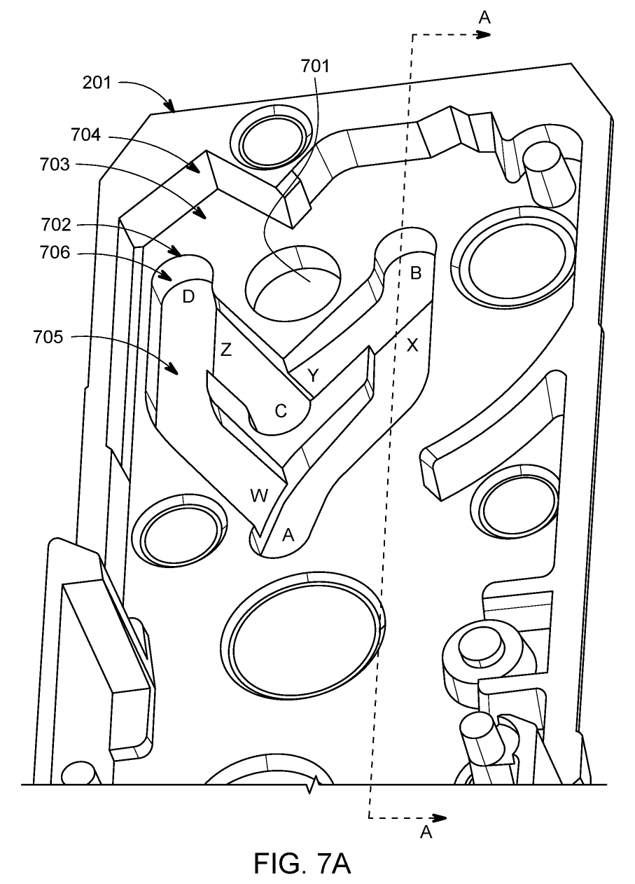

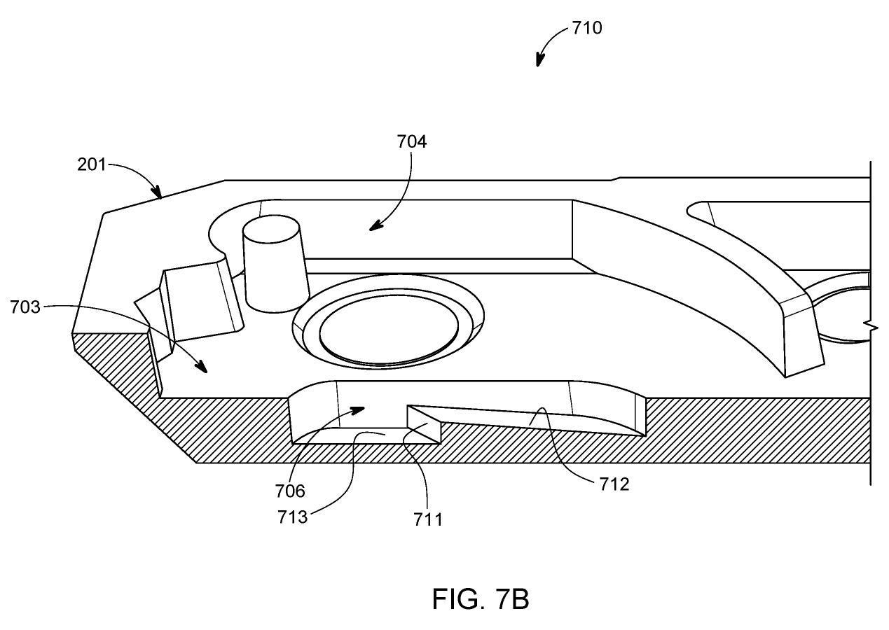

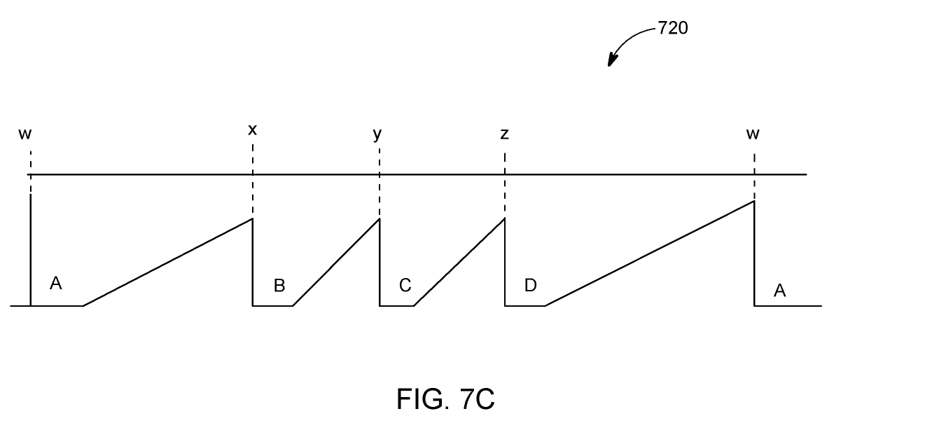

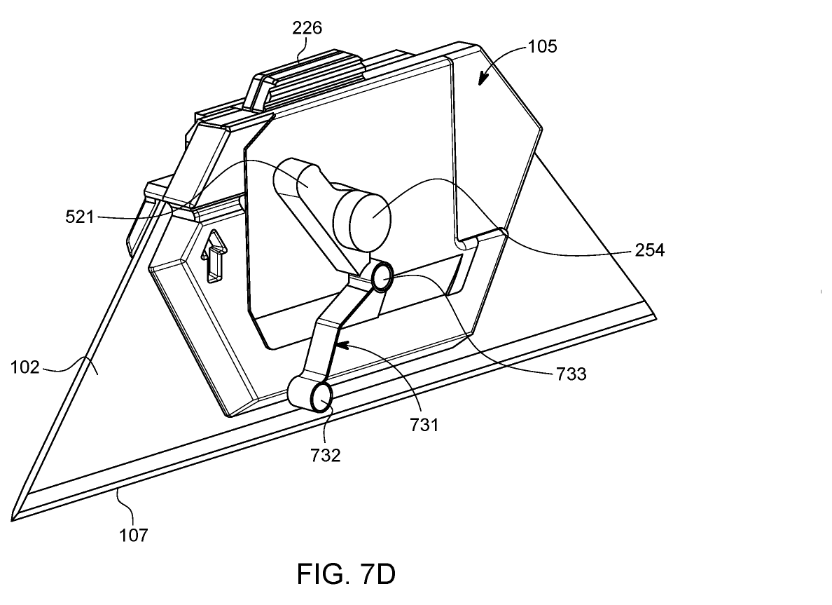

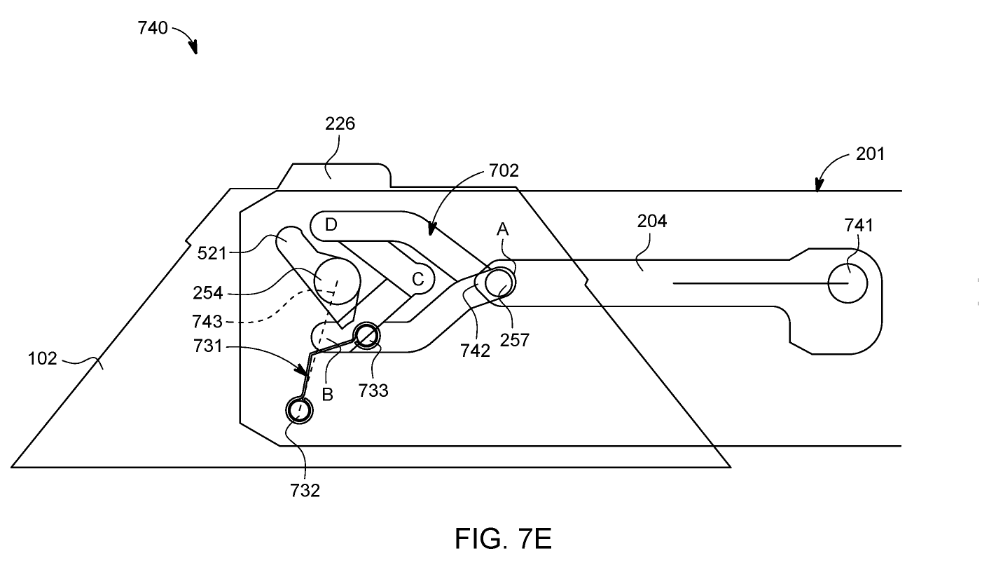

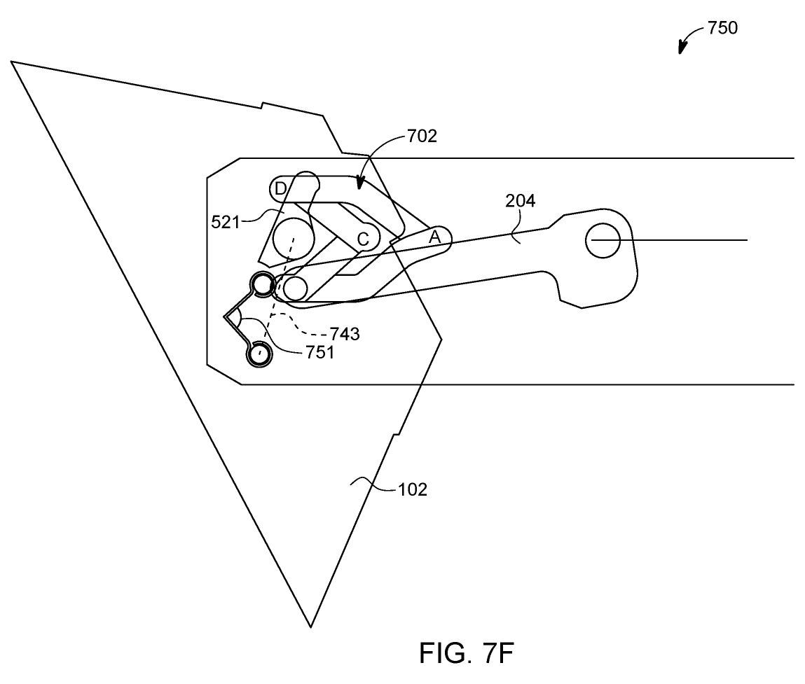

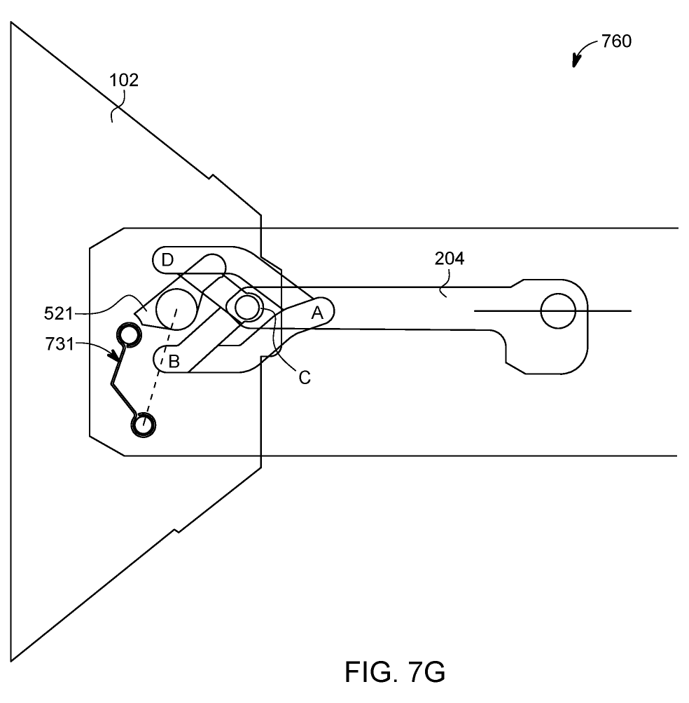

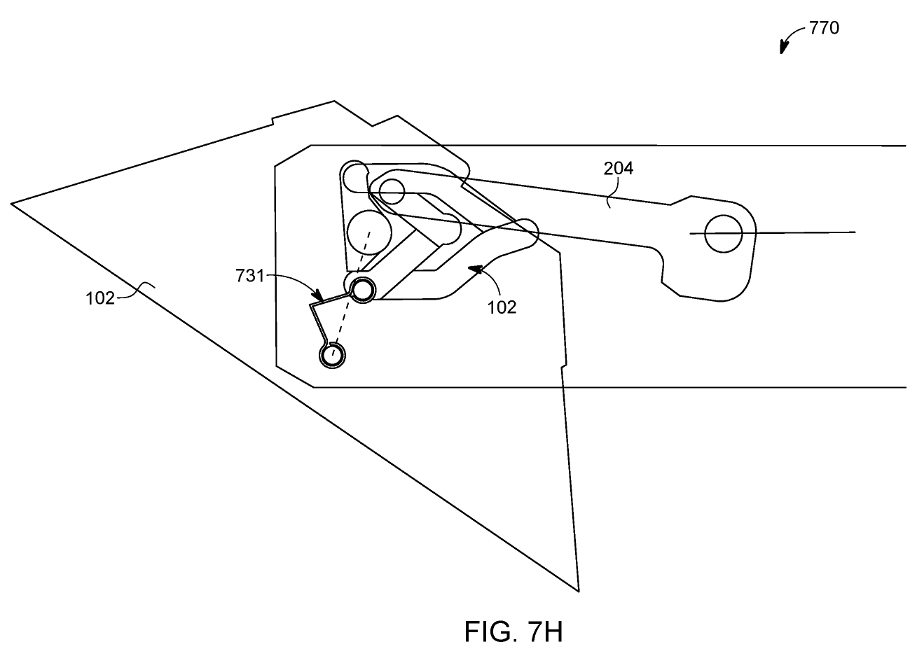

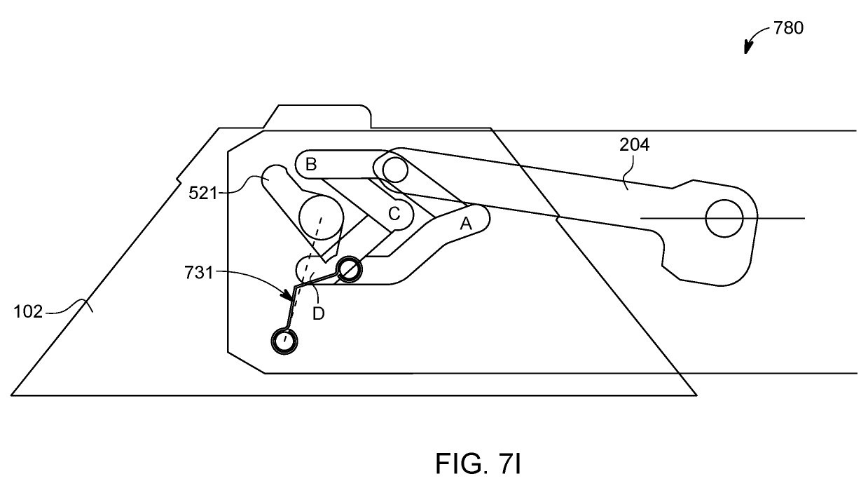

FIG. 7A shows an example cut-away of the blade carriage assembly with a cross- section A-A and internal tracks that guide knife configuration conversion. In various embodiments, the cut-away view 700 incudes the blade carriage assembly 201, blade clamp pivot hole 701, guide grooves network 702, carriage interior recess 703, carriage recess sidewalls 704, guide tracks or grooves 705, and grooves pin landings 706. This figure also shows a cross- section A-A further discussed below with respect to other figures.

In various embodiments, the rotation of the blade clamp assembly 105 is actuated within the interior space of the blade carriage assembly 201 using the guide grooves (or tracks) network 702. The slider guide pin 257 (see FIG. 2C), further described below with respect to other figures, fits within the guide grooves (or tracks) 705 and on user action traverses the guide grooves network 702 in one direction (clockwise-CW or counterclockwise-CCW, in various embodiments). If the user successively cycles through the two operational modes (cutting, scraping) of the convertible knife 109, the slider guide pin 257 traverses the guide grooves network 702 in the same direction for each cycle.

In various embodiments, the guide grooves network 702 includes multiple guide grooves 705. Each of the guide grooves 705 in the guide grooves network 702 is a groove segment within the groove network and has a groove pin landing 706, which is a stable landing and holding area for the slider guide pin 257 until the slider guide pin 257 is forced to move on to the next guide groove and settle in a new groove pin landing 706. In this figure, the grooves pin landings areas are labeled as A, B, C, and D.

In various embodiments, each guide groove 705 has an upward slope, away from the bottom or floor of the carriage interior recess 703, that leads to the grooves pin landing 706 of the guide groove 705, getting ready to move on to the next guide groove segment. Before each of the next grooves pin landings 706, a vertical drop is incorporated that functions to drop the slider guide pin 257 into the grooves pin landing 706, and also cancel out the upward slope of the guide groove 705. In this sense, the guide grooves network 702 resembles a path with a sawtooth form going up and coming back down with respect to the floor of the carrier interior recess 703. In FIG. 7A, the vertical drops before each of the grooves pin landings 706, are labeled as X, Y, Z, and W. The grooves pin landing 706 for each guide groove 705 is a straight extension of the guide groove 705, but is angled with respect to the next guide groove in a traversal order of the slider guide pin 257 through the guide grooves network 702. The grooves pin landings 706 provide an extra space, in addition to the operational length (defined as the length of one guide grooves 705 to beginning of the next guide grooves 705) of the guide grooves 705 to prevent the slider guide pin 257 from prematurely entering the next groove segment or backing into the previous one, or binding on the guide grooves 705 sidewalls.

FIG. 7B shows an example view of the cross-section A-A of FIG. 7A of the internal guide grooves of the blade carriage assembly. In various embodiments, the cross- sectional view A-A 710 includes blade carriage assembly 201, carriage interior recess 703, carriage recess sidewalls 704, grooves pin landing 706, groove vertical drop 711, sloped groove floor 712, and pin landing floor 713.

In various embodiments, the section of the guide groove 705 shown has an upward sloping groove floor 712 and a groove vertical drop 711 leading to the groove pin landing 706 with pin landing floor 713. A slider guide pin 257 moving along the guide groove 705 towards the pin landing 706 follows the sloped groove floor 712 up and then falls off the groove vertical drop 711 into the pin landing floor 713. The same motion of the slider guide pin 257 happens when it traverses the guide groove network 702.

FIG. 7C shows an example operational diagram of conversion of knife configurations. In various embodiments, the operational diagram 720 shows a linearized version of the guide groove network 702 and the vertical path of the slider guide pin 257 as it traverses the guide groove network 702.

The sawtooth shaped curve depicts the vertical path of the slider guide pin 257 falling off each of the groove vertical drops 711, labeled as X, Y, Z, and W as the slider guide pin 257 traverses the guide grooves network 702. Starting from the left side of this figure, the slider guide pin 257 falls off the vertical drop W onto the groove pin landing A, which is flat (not sloped down or up). Continuing with the traversal, the slider guide pin 257 moves up on the upward sloping sloped groove floor 712 until it reaches the next groove vertical drop, X and drops onto the groove pin landing B. This up and down motion of the slider guide pin 257 along the paths of the guide groove network 702 continues until the slider guide pin 257 cycles back to the groove vertical drop W, and the cycle may begin again the same way.

In various embodiments, the motion of the slider guide pin 257 is actuated by the actions of the user pressing slider button 103 and, in turn, pushing blade carriage assembly 201 in the same direction. The slider arm 203 via slider finger 204 (see FIG. 2A) drive the slider guide pin 257 through the guide grooves network 702. The user, by a single and same action of pushing the slider assembly 108 forward and letting it return and then pushing it forward again, causes the slider guide pin 257 to go through the guide grooves network 702 and convert the operation mode of the knife from cutting to scraping and from scraping to cutting. Different actions are not employed by the user to transition from one mode to another and back to the initial mode.

In various embodiments, the slider guide pin 257 has to move in one direction (from groove pin landings A to B to C to D and back to A) as each groove vertical drop 711 (X, Y, Z, W) prevents the slider guide pin 257 to go backwards.

FIG. 7D shows an example view of the blade clamp assembly with clamp pivot and blade rotation bar. In various embodiments, the view 730 includes blade 102, blade edge 107, blade clamp assembly 105, blade release button 226, blade clamp pivot 254, blade rotation bar 521, blade rotation spring 731, spring carriage end 732, and spring clamp end 733.

In various embodiments, the blade rotation spring 731 is coupled with the interior of the blade carriage assembly 201 via the spring carriage end 732, and is coupled with the blade clamp assembly 105 via the spring clamp end 733. When the slider finger 204 pushes on the blade rotation bar 521, as described in more detail below with respect to other figures, the blade rotation spring 731 assists in the rotation of the blade clamp assembly 105. The blade rotation spring 731 assists in the rotation of the blade in both CW and CCW directions.

In various embodiments, the blade 102 is exposed equally on both sides of the blade clamp assembly 105 to provide sufficient blade exposure, in both the cutting edge and the pointed corners or the cutting blade edge 107, for deeper scraping and deeper cutting into material compared with a greater coverage (covered or enclosed portion of blade area) of the blade by the blade clamp assembly 105. In some embodiments, the blade

FIG. 7E shows an example view of a knife mode conversion mechanism in the cutting mode. In various embodiments, the view 740 includes blade 102, blade carriage assembly 201, blade release 226, blade clamp pivot 254, slider finger 204, slider guide pin 257, blade rotation bar 521, guide grooves network 702, blade rotation spring 731, spring carriage end 732, spring clamp end 733, slider arm-finger coupling 741, slider finger tip 742, spring-pivot line 743, and groove pin landings A, B, C, and D.

In various embodiments, the slider guide pin 257 resting in the groove pin landing A corresponds with the knife configuration (cutting mode), while the slider guide pin 257 resting in the groove pin landing C corresponds with the scraper configuration (scraping mode).

In various embodiments, slider arm-finger coupling 741 is used to rotatably couple (for example, as a pin-joint) slider arm 203 with the slider finger 204. This rotational coupling allows the slider finger 204 to be pushed forward by the slider arm 203 while also partially rotating to accommodate the slider guide pin 257 to follow the guide grooves 705 in the guide grooves network 702.

In various embodiments with the sider guide pin 257 initially resting at the groove pin landing A, and the knife being in the cutting mode as shown, as slider finger 204 is pushed forward (towards blade 102) by the user via slider button 103, slider finger tip 742 pushes the slider guide pin 257 into one of the guide grooves 705 leading towards the groove pin landing B. This movement of the slider finger tip 742 also pushes the blade rotation bar 521 to rotate blade clamp assembly 105 CW. The spring clamp end 733, which is coupled with the blade clamp assembly 105, also rotates the same way. This rotation of the spring clamp end 733, which is initially on the right side of the spring-pivot line 743, causes it to cross over to the left side of the spring-pivot line 743, reversing the moment force about the blade clamp pivot 254, assisting the CW rotation of blade clamp assembly 105. This process is further depicted in FIG. 7F, described below.

FIG. 7F shows an example view of the knife mode conversion mechanism in transition between the cutting mode and the scraping mode. In various embodiments, view 750 includes blade 102, slider finger 204, blade rotation bar 521, guide grooves network 702, spring- pivot line 743, and rotation spring bending angle 751.

In various embodiments, as the blade clamp assembly 105 partially rotates, sufficiently to cause the spring clamp end 733 to cross over to the left of the spring-pivot line 743. During this transition of the spring clamp end 733 from the right side to the left side of the spring-pivot line 743, the blade rotation spring 731 is compressed by bending and decreasing the rotation spring bending angle 751, storing energy. Once the spring clamp end 733 crosses to the left side, it starts to decompress, releasing its energy and delivering a further rotational force to the blade clamp assembly 105 CW to complete its rotation of 90 degrees compared with its original position. In this configuration, the blade edge 107 has rotated 90 degrees compared to its orientation when in knife configuration, shown in FIG. 7E. At this point, releasing the slider button 103 by the user pulls the slider finger 204 back causing the slider guide pin 257 to move from groove pin landing B to groove pin landing C. This process is further described below in FIG. 7G.

FIG. 7G shows an example view of a knife mode conversion mechanism in scraping mode. In various embodiments the view 760 includes blade 102, slider finger 204, blade rotation bar 521, and blade rotation spring 731.

In various embodiments, in this figure the blade 102 is shown as facing forward and in scraping mode. In this configuration, the blade rotation spring 731 is fully decompressed and stays on the left side of the spring-pivot line 743. The slider guide pin 257 has moved to the groove pin landing C, which corresponds to the scraper configuration of the convertible knife 109. In this configuration, the slider button 103 has been released by the user.

FIG. 7H shows an example view of a knife mode conversion mechanism in transition between the scraping mode and the cutting mode. In various embodiments, view 770 includes blade 102, slider finger 204, guide grooves network 702, and blade rotation spring 731.

In various embodiments, this figure shows a state of the blade clamp assembly 105 in which the user has again pressed the slider button 103 and moved the slider assembly 108 and the slider finger 204 forward, causing the slider finger tip 742 to press against the blade rotation bar 521, turning the blade clamp assembly 105 CCW. At this point the spring clamp end 733 also rotates CCW and crosses from the left side of the spring-pivot line 743 to the right side, compressing the blade rotation spring 731, creating a moment force to complete the rotation of the blade clamp assembly 105 back to the knife configuration. At this point the slider guide pin 257 is at the groove pin landing D. This process is further described with respect to FIG. 7I below.

FIG. 7I shows an example view of a knife mode conversion mechanism in cutting mode while the mechanism is still in transition. In various embodiments view 780 includes blade 102, slider finger 204, blade rotation bar 521, and blade rotation spring 731.

In various embodiments, in this state of the convertible knife 102, the blade 102 is fully rotated to face down in cutting mode. The blade rotation spring 731 is also fully decompressed and on the right side of the spring-pivot line 743. At this point, the user has released the slider button 103 and the slider finger 204 is pulled back causing the slider guide pin 257 to move from groove pin landing D to groove pin landing A, completing the cycle.

It will be understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as "open" terms (e.g., the term "including" should be interpreted as "including but not limited to," the term "having" should be interpreted as "having at least," the term "includes" should be interpreted as "includes but is not limited to," etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to inventions containing only one such recitation, even when the same claim includes the introductory phrases "one or more" or "at least one" and indefinite articles such as "a" or "an" (e.g., "a" and/or "an" should typically be interpreted to mean "at least one" or "one or more"); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of "two recitations," without other modifiers, typically means at least two recitations, or two or more recitations). Furthermore, in those instances where a convention analogous to "at least one of A, B, and C, etc." is used, in general such a construction is intended in the sense one having skill in the art would understand the convention (e.g., "a system having at least one of A, B, and C" would include but not be limited to systems that have A alone, B alone, C alone, A and B together, A and C together, B and C together, and/or A, B, and C together, etc.). In those instances where a convention analogous to "at least one of A, B, or C, etc." is used, in general such a construction is intended in the sense one having skill in the art would understand the convention (e.g., "a system having at least one of A, B, or C" would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase "A or B" will be understood to include the possibilities of "A" or "B" or "A and B." It is further understood that any phrase of the form "A/B" shall mean any one of "A", "B", "A or B", or "A and B". This construct includes the phrase "and/or" itself.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A convertible knife comprising:
a knife housing with a hollow interior space;
a blade carriage assembly slidably deployed within the knife housing;
a blade clamp assembly rotatably coupled with the blade carriage assembly; and
a blade release assembly coupled with the blade clamp assembly and including at least two blade pins to securely hold a blade in the blade clamp assembly, wherein one of the at least two blade pins engages a notch on a top edge of the blade and the other one of the at least two blade pins engage a central perforation of the blade.

2. The convertible knife of claim 1, further comprising a slider button surrounded by a safety frame coupled with the blade carriage assembly.

3. The convertible knife of claim 1, further comprising sliding strips incorporated on the blade carriage assembly to enhance slidability of the blade carriage assembly within the knife housing.

4. The convertible knife of claim 1, wherein the hollow interior includes a plurality of stops to engage the blade carriage assembly and hold the blade carriage assembly at predetermined positions within the knife housing.

5. The convertible knife of claim 1, wherein the blade carriage assembly includes a stop to position the blade carriage assembly to convert a mode of operation of the convertible knife.

6. The convertible knife of claim 1, wherein the blade clamp assembly includes a blade clamp spring to press and hold a blade inside the blade clamp assembly.

7. The convertible knife of claim 1, further comprising a paint can opener.

8. The convertible knife of claim 1, wherein the blade clamp assembly including three blade pins, wherein two of the blade pins engage two notches on the top edge of the blade and the other one of the three blade pins engage the central perforation.

9. A dual-mode knife comprising:
a hollow knife housing;
a blade carriage assembly deployed within the hollow knife housing;
a blade clamp assembly enclosing a limited portion of a blade to expose more of the blade near pointed corners of the blade for deeper cutting and scraping; and
a slider button coupled with the blade carriage assembly and the hollow knife housing;
wherein the slider button includes at least one detent to engage stops incorporated in the hollow knife housing and hold the blade carriage assembly in one of several predetermined positions within the hollow knife housing.

10. The dual-mode knife of claim 9, further comprising a blade clamp assembly to hold a blade.

11. The dual-mode knife of claim 9, further comprising a slider assembly including the slider button and a slider safety frame surrounding the slider button.

12. The dual-mode knife of claim 9, wherein a first detent of the slider button engages stops in the hollow knife housing and the second detent engages a recess in the blade carriage assembly.

13. The dual-mode knife of claim 10, wherein the blade is structurally supported by a combination of the knife housing, the blade carriage assembly enclosed by the knife housing, and the blade clamp assembly enclosed by the blade carriage assembly, wherein the blade is supported on all sides including top, bottom, and sides to resist deformation and movement of the blade.

14. The dual-mode knife of claim 13, wherein the knife housing asymmetrically surrounds the top and bottom of the blade, creating a smaller distance between the blade and a bottom surface of the knife housing and greater distance between the blade and a top surface of the knife housing.

15. The dual-mode knife of claim 13, wherein the blade clamp assembly is rotatable to form a knife configuration in a first orientation and to form a scraper configuration in a second orientation.

16. A method of converting a first mode of operation to a second mode of operation in a dual-mode knife, the method comprising:
pressing a slider button, having an integrated detent, to slide a blade carriage assembly forward in a hollow knife housing; and
rotating a blade clamp assembly, coupled with the blade carriage assembly, from a first position to a second position to convert from the first mode of operation to the second mode of operation;
wherein the blade carriage assembly includes a guide grooves network having a plurality guide grooves, each guide groove having a groove pin landing.

17. The method of claim 16, further comprising pushing a rotation bar to rotate the blade clamp assembly.

18. The method of claim 16, further comprising releasing the slider button to stop the blade carriage assembly at a predetermined position within the hollow knife housing.

19. The method of claim 16, wherein the first position of the blade clamp assembly corresponds with a cutting mode and the second position of the blade clamp assembly corresponds with a scraping mode.

20. The method of claim 19, wherein the blade clamp assembly includes a blade release button that is inaccessible when the blade clamp assembly is in the scraping mode.

21. A dual-mode knife, comprising:
a hollow knife housing;
a blade carriage assembly deployed within the hollow knife body; and
a blade clamp assembly to hold a blade, the blade clamp assembly coupled with the blade carriage assembly;
wherein the blade is structurally supported by a combination of the knife housing, the blade carriage assembly, and the blade clamp assembly, wherein the blade is supported on all sides including top, bottom, and sides to resist deformation and movement of the blade.

22. A dual-mode knife, comprising:
a hollow knife housing;
a blade carriage assembly deployed within the hollow knife body; and
a blade clamp assembly to hold a blade, the blade clamp assembly coupled with the blade carriage assembly;
wherein the knife housing asymmetrically surrounds the top and bottom of the blade, creating a smaller distance between the blade and a bottom surface of the knife housing and greater distance between the blade and a top surface of the knife housing.
